(19) United States
(12) Patent Application Publication
(10) Pub. No.: US 2026/0303603 A1
(43) Pub. Date: Oct. 1, 2026

(54) SYSTEMS AND METHODS FOR COMMUNICATION PROTOCOL ENHANCEMENTS WITHIN A LIMITED RESOURCE ENVIRONMENT

(71) Applicant: Adeia Guides Inc., San Jose, CA (US)

(72) Inventors: Charles Dasher, Lawrenceville, GA (US); Reda Harb, Saint Petersburg, FL (US); Evgeny Kaminsky, Hollywood, FL (US)

(21) Appl. No.: 19/092,820

(22) Filed: Mar. 27, 2025

(51) Int. Cl. H04L 9/40

(52) U.S. Cl. CPC H04L 63/102; H04L 63/107

(57) ABSTRACT

Systems and methods are provided herein for monitoring a resource environment of a connected device to intelligently modify communication parameters. More particularly, systems and related methods are disclosed for determining a condition score of a device based on measured resource parameters and, based on the condition score, adjusting transmission behavior. For example, the system causes one or more of a message keep-alive interval, a batch size, a transmission interval, an error-resiliency mechanism, or a maximum frame size to be adjusted in accordance with the condition score. Additionally, the system identifies nearby devices and establishes a proxy connection with a nearby device when the resource environment of the first device indicates its necessity. The system further determines an engagement level of a user with a connected device and adjusts the connection behavior based on the engagement level.

### BACKGROUND

This disclosure is related to techniques for improving communication protocols between two devices when in a low resource environment.

### SUMMARY

With the widespread use of mobile and wearable devices, energy-efficient communication protocols are becoming essential, particularly for real-time applications reliant on real-time connections and real-time data transfers. In one approach, communication protocols (e.g., WebSocket protocols) are designed with an emphasis on low latency and high data throughput, often disregarding power efficiency. In particular, standard WebSocket implementations do not dynamically adjust transmission frequency, message batching, or connection handshakes based on the real-time energy state of the client device. This results in potentially unnecessary battery depletion and increased processing demands, especially during idle periods or low-bandwidth network conditions.

To help address these problems, systems and methods are disclosed herein for conserving device energy through adaptive features, independent of network-layer prioritization and packet-marking schemes. For example, systems and methods are disclosed herein for monitoring resource parameters of connected devices and based on the measured resource parameters, applying modifications to the connection channel parameters. In some embodiments, the system establishes a communication channel over a network between a device and a server, wherein control data is transmitted over the communication channel to maintain the communication channel. In some implementations, the system determines one or more parameters indicative of one or more resources available to the device. In some embodiments, the system calculates a condition score for the device based at least in part on the one or more parameters. In some implementations, the system updates at least one attribute of the control data based at least in part on determining that the condition score is below a threshold.

Such systems and methods, for example, provide resource monitoring and message transmission adaptations to optimize the use of resources available to the devices using the established communication channel. Thus, the system optimizes resource usage by modifying message transmission behavior according to determined resource availability. For example, the disclosed techniques may help extend battery life in environments where power efficiency is a priority without sacrificing essential connectivity. For a service that maintains, for example, millions of persistent WebSocket connections, even small reductions in data flow per user can lead to significant overall savings in bandwidth and server processing. By dynamically adjusting the delivery of WebSocket updates based on various factors (e.g., user presence, device proximity, engagement level and/or other factors), application providers, service providers, and content providers may optimize resource allocation, reducing the need to push updates to inactive devices and focusing instead on engaged users. The disclosed techniques may improve efficiency of WebSocket protocols (and any other suitable protocol standards) at the application layer for individual devices, e.g., by providing improved techniques for data prioritization, message batching, and resource-efficient transmission to reduce infrastructure load.

In some embodiments, the system determines one or more server parameters indicative of one or more resources available to the server, calculates a server condition score for the server based at least in part on the one or more server parameters, and updates at least one attribute of the control data based at least in part on the server condition score. In some implementations, the system establishes the communication channel using a WebSocket protocol, transmits control data that is associated with the WebSocket protocol, and modifies at least one attribute of the control data based at least in part on the WebSocket protocol and the condition score. In some embodiments, the system determines one or more of a battery level, network bandwidth, network latency, central processing unit (CPU) usage, or general processing unit (GPU) usage of a device (e.g., one or more parameters) and calculates the condition score by normalizing each parameter of the one or more parameters and applying respective weights to each normalized parameter. In some implementations, the system transmits keep-alive messages that are transmitted at a first frequency and updates the first frequency to a second frequency that is less than the first frequency (e.g., based on the condition score). In some embodiments, the system transmits an indication of a size and a frequency of messages to be transmitted by the server to the device and increases the size and decreases the frequency of messages transmitted by the server to the device (e.g., based on the condition score). In some embodiments, the system transmits an indication of a compression level for messages to be transmitted by the server to the device and increases the compression level for messages transmitted by the server to the device (e.g., based on the condition score).

In some implementations, the system transmits an indication of prioritizing a speed of message transmission over error resilience of message transmission and, based on the condition score, switches to prioritizing error resilience of message transmission over the speed of message transmission. In some embodiments, the system transmits an indication of a maximum frame size of data to be transmitted by the server to the device; decreases, based on the condition score, the maximum frame size; and utilizes adaptive frame segmentation to reduce a frame size of data to be transmitted to the device (e.g., based at least in part on the decreased maximum frame size). In some implementations, the system identifies a second device in the proximity of the first device and (e.g., based on the condition score) transmits an indication that data is to be transmitted to the second device instead of the first device (e.g., because the second device is proximate to the first device and is in a better resource environment than the first device). In some embodiments, the system identifies the second device based one or more user accounts associated with the first device being associated with the second device. In some embodiments, the second device subsequently transmits the data received from the server to the first device. In some implementations, the system determines an engagement level of a user with the device based at least in part on one or more of a frequency of interactions with the device or a determined proximity of the user to the device and, based at least in part on the engagement level, refrains from transmitting non-critical data to the device. In some embodiments, the system detects movement of the device by a sensor associated with the device to determine the engagement level.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 depicts an illustrative system for adjusting communication protocols established for two devices based on available resources, in accordance with some embodiments of this disclosure.

FIG. 2 is a sequence diagram of adjustable communication protocols, in accordance with some embodiments of this disclosure.

FIG. 3 is a sequence diagram of adjustable communication protocols, in accordance with some embodiments of this disclosure.

FIG. 4 is a sequence diagram of adjustable communication protocols, in accordance with some embodiments of this disclosure.

FIG. 5 is a sequence diagram of adjustable communication protocols, in accordance with some embodiments of this disclosure.

FIG. 6 is a sequence diagram of adjustable communication protocols, in accordance with some embodiments of this disclosure.

FIG. 7 is a sequence diagram of adjustable communication protocols, in accordance with some embodiments of this disclosure.

FIG. 8 is a sequence diagram of adjustable communication protocols, in accordance with some embodiments of this disclosure.

FIG. 9 is a sequence diagram of adjustable communication protocols, in accordance with some embodiments of this disclosure.

FIG. 10 is a sequence diagram of adjustable communication protocols, in accordance with some embodiments of this disclosure.

FIG. 11 shows illustrative devices and systems for using adjustable communication protocols, in accordance with some embodiments of this disclosure.

FIG. 12 shows illustrative devices and systems for using adjustable communication protocols, in accordance with some embodiments of this disclosure.

FIG. 13 is flowchart of a detailed illustrative process for managing adjustable communication protocols, in accordance with some embodiments of this disclosure.

### DETAILED DESCRIPTION

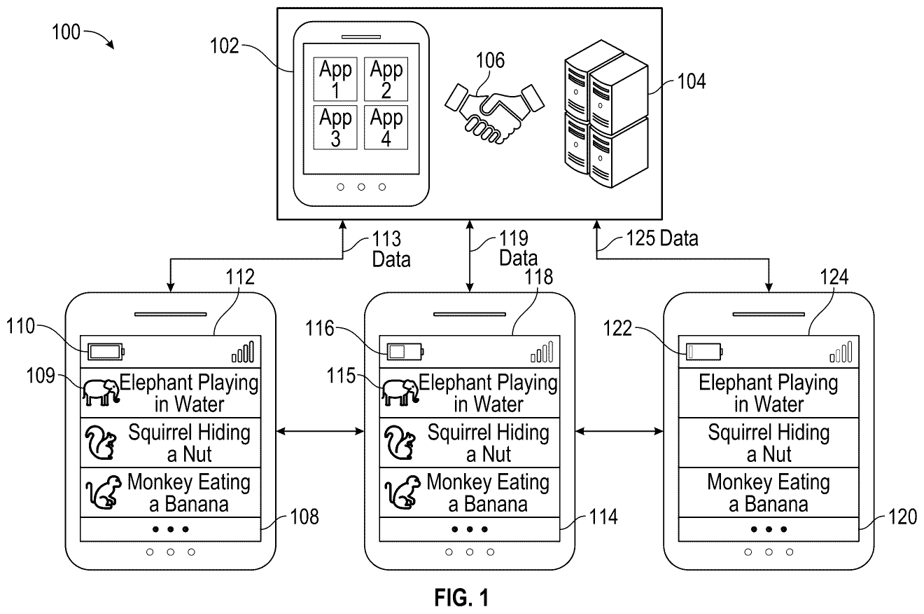

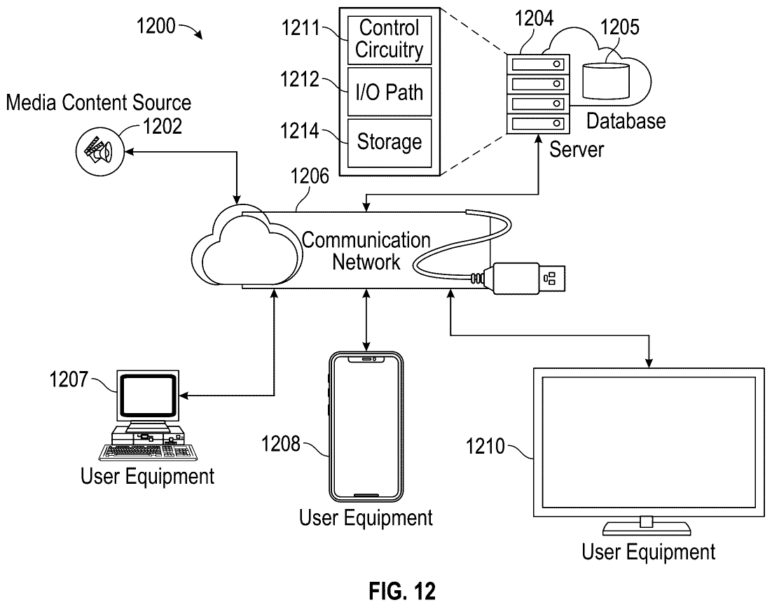

FIG. 1 depicts system 100 for adjusting communication protocols established for two devices based on available resources, in accordance with some embodiments of this disclosure. In some embodiments, system 100 (also referred to herein as “the system”) may comprise or correspond to and/or be implemented at/on user device 102 (also referred to herein as client device 102), one or more servers, or any other suitable device, service, or platform, or any combination thereof. The system may comprise or correspond to a communication protocol used between two devices (e.g. user device 102 and application server 104), which may be established and utilized at least in part by user device 102, application server 104, and/or user equipment 1207, 1208, or 1210 of FIG. 12 and/or at one or more remote servers (e.g., server 1204 of FIG. 12) and/or at or distributed across any of one or more other suitable computing devices or network equipment, in communication over any suitable number and/or types of networks (e.g., the Internet, cellular networks, satellite networks, and/or any other suitable networks). The system (e.g., system 100) may be configured to perform the functionalities (or any suitable portion of the functionalities) described herein. In some embodiments, the system may be a stand-alone application or may be incorporated as part of any suitable application or system. The system may comprise or employ any suitable number of displays, sensors or devices such as, for example, those described in FIGS. 1-13, or any other suitable software and/or hardware components, or any combination thereof.

In some embodiments, the system (e.g., system 100) may be provided to (and accessed by) a particular computing device, may be provided via an application programming interface (API), or may be provided as an add-on application to another platform or application. In some embodiments, software tools (e.g., one or more software development kits (SDKs)) may be provided to any suitable party, to enable the party to implement the functionalities described herein.

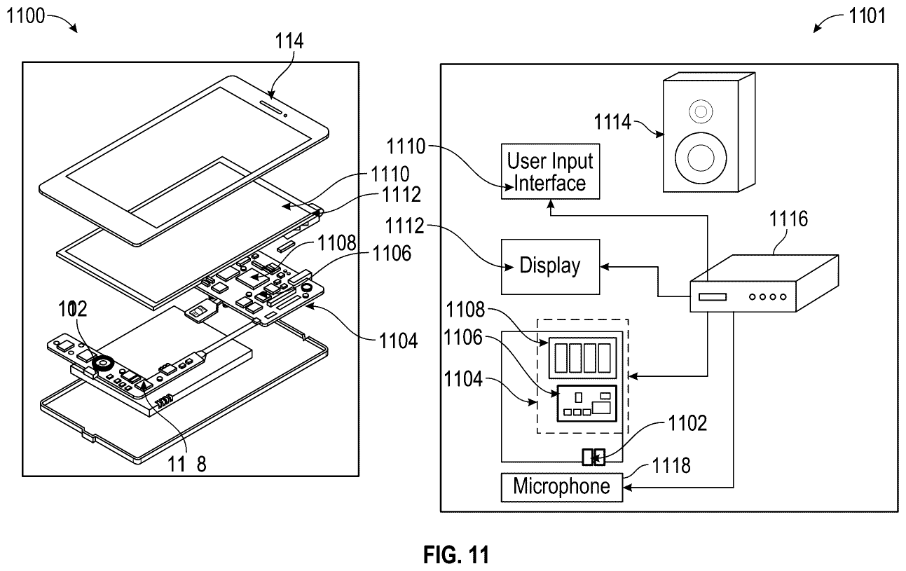

In some implementations, system 100 comprises user device 102 of FIG. 1, application server 104, or any number of devices (e.g., server 1204 of FIG. 12), comprising software and hardware components, such as, for example, control circuitry and memory, and may correspond to one or more of devices 1207, 1208, and/or 1210 of FIG. 12. In some embodiments, the control circuitry of user device 102 is control circuitry 1104, as further described in FIG. 11 below. The hardware components and applications installed on user device 102 may be managed by an operating system (OS) (e.g., iOS, Android, webOS). System 100 may implement the techniques depicted in FIG. 1 based on instructions stored in non-transitory memory (e.g., non-transitory memory 1108 of FIG. 11, or storage 1214 of FIG. 12). System 100 enables user device 102 to download, install or otherwise access resources and/or applications (e.g., web browsers, databases, Instagram, Spotify, one or more applications native to the OS, third-party applications, or any other suitable applications or resources, or any suitable combination thereof) and allows user device 102 to establish communication channels with these applications. For example, in some embodiments, one or more applications are installed on user device 102 and communicate with user device 102 via backend services (e.g., over the Internet via a server of the one or more applications).

In some embodiments, user device 102 downloads and/or accesses applications or other resources over communication network 1206 of FIG. 12. System 100 may establish communication channels between user device 102 and one or more servers or other devices providing applications or resources to user device 102. System 100 may establish the communication channels with applications installed on and/or accessible to user device 102 by using an API, a software interface that allows two or more applications to communicate with each other.

In some embodiments, user device 102 may be a mobile device such as, for example, a smartphone or tablet. In some embodiments, user device 102 may comprise or correspond to a laptop computer, a personal computer, a desktop computer, an Internet of Things (IOT) device, a smart television, a smart watch or wearable device, smart glasses, a stereoscopic display, a wearable camera, extended reality (XR) glasses, XR goggles, a near-eye display device, or any other suitable user equipment or computing device, or any combination thereof.

The present disclosure provides systems and methods for modifying one or more communication protocols (e.g., WebSocket protocol) to optimize energy usage in applications where continuous connectivity is generally desirable, but power constraints are present. Through real-time monitoring and adaptive protocol adjustments, this system dynamically balances energy consumption with connection integrity and transmission frequency, ensuring devices can maintain connectivity without excessive battery drain. The disclosed energy efficient WebSocket Protocol enhancement “EE” introduces several energy-optimizing improvements on the WebSocket standard (RFC 6455) that allow devices to dynamically adjust transmission behavior based on real-time device monitoring. In some embodiments, these modifications focus on lowering power consumption in resource-limited environments by integrating condition-aware adjustments directly into WebSocket operations.

The disclosed energy efficient communication protocol (e.g., WebSocket protocol) enhancement (e.g., “EE”) introduces several energy-optimizing improvements on standard communication protocols (e.g., WebSocket standard RFC 6455) that allow devices to dynamically adjust transmission behavior based on real-time device monitoring. The WebSocket protocol standard is discussed in more detail in Fette et al., Request for comments (RFC) 6455: “The WebSocket Protocol,” Internet Engineering Task Force (IETF), the entire contents of which are hereby incorporated by reference herein in their entirety. For example, in some implementations, the disclosed system incorporates a real-time monitoring engine (RTME) that periodically collects data on device parameters like battery level, CPU/GPU usage, and network quality. In some embodiments, the system uses these parameters to calculate a condition score that determines the resources available to a device at any given time. In some implementations, by adjusting behaviors (e.g., WebSocket behaviors) such as, for example, keep-alive signal frequency, message batching (e.g., at least one attribute of control data), and connection handshakes, the system enables devices to optimize energy use in real time based on current operating conditions (e.g., by modifying the connection protocol).

In some embodiments, while standard connections (e.g., WebSocket connections) maintain a continuous link with periodic keep-alive messages (e.g., which drains power during extended idle times), the disclosed system reduces the frequency of these signals when the condition score (e.g., of a device) indicates low battery or limited network resources. In some implementations, this adaptive approach conserves energy by limiting transmissions when the device is in a low-energy state (e.g., or based on user settings indicating a preference for saving energy/power), reverting to standard frequencies only when conditions improve (e.g., the device is plugged into a power source).

In some embodiments, the system initiates an energy-aware connection (e.g., WebSocket connection) from the outset. For example, in some implementations, during the handshake process, the client and server agree to engage in low-power operation modes tailored for devices (e.g., based on resource availability and/or user preferences). In some embodiments, the system enables energy-saving measures, such as, for example, compressing initial message payloads or extending timeouts, to be applied immediately, rather than after the connection is established. In some implementations, instead of transmitting messages as they are generated, the system uses intelligent frame batching to group multiple frames (e.g., Web Socket frames) into a single batch. In some embodiments, the system reduces the frequency of transmissions, thereby conserving energy by limiting the number of times the network interface of the device is activated. In some implementations, the system adjusts the size and timing of batches in real time based on a condition score (e.g., of the device and/or server), causing larger batches to be sent when the device is under power constraints. In some embodiments, when the system determines that the device and/or server are in favorable conditions, the system reverts to more frequent transmissions for reduced latency.

In some embodiments, the system uses dynamic message compression to adjust the compression level of messages (e.g., WebSocket messages) in real-time based on a determined condition score (e.g., of the device or server) that indicates a resource environment. In some implementations, when the system determines that resources are limited (e.g., based on measured resource parameters), the system applies a higher compression rate, thereby reducing message sizes and saving transmission energy. In some embodiments, as resources improve, the system reduces (e.g., relaxes) the compression rate to prioritize speed and reduce processing load. In some implementations, existing extensions for WebSockets, such as, for example, per-message deflate which enables message-by-message compression to reduce the size of data sent over WebSocket connections which, when enabled, compresses individual Web Socket messages using the deflate compression algorithm, thereby reducing the payload size, lowering network usage and potentially speeding up message transmission. In some embodiments, during the handshake (e.g., WebSocket handshake), the client and server negotiate the use of the per-message deflate extension. In some implementations, when both sides support it, the system enables the extension for the session. In some embodiments, for each message, the sender compresses the payload before sending it to the receiver. In some implementations, upon receiving a compressed message, the receiver decompresses it before passing it on to the application. In some embodiments, the system applies per-message deflate selectively, meaning messages are only compressed if it would benefit network efficiency. For instance, in some implementations, small messages are not compressed, as the compression overhead could outweigh the data savings.

In some embodiments, the system uses error-resilient transmission to apply error-resistant encoding during low-power conditions, thereby reducing data loss and minimizing the need for retransmissions in unstable network environments. In some implementations, by prioritizing error resilience over speed when resources are constrained, the system conserves energy that would otherwise be spent on repeated transmissions. In some embodiments, the system uses reliability mechanisms in network communications to ensure that data is transmitted accurately and completely, even in conditions where network stability may be compromised. In some implementations, (e.g., in the context of WebSocket and other real-time communication protocols) the system uses reliability mechanisms to manage and mitigate issues such as, for example, packet loss, data corruption, and fluctuating network conditions. In some embodiments, the system uses these mechanisms for applications requiring continuous data flow to help maintain a seamless user experience by minimizing interruptions and data inaccuracies.

In some embodiments, the system uses a common reliability approach (e.g., acknowledgments (ACKs)), causing the receiving endpoint to confirm receipt of each message or data packet. In some implementations, when an expected acknowledgment is not received within a specified time, the sender assumes the data was lost and retransmits it. In some embodiments, the system uses another relevant reliability mechanism (e.g., forward error correction (FEC)) to add redundancy to data packets. In some implementations, the system uses FEC to embed error-correcting codes in each message, thereby allowing the receiver to detect and correct certain errors without needing retransmission. In some embodiments, the system uses FEC for real-time applications (e.g., where latency must be minimized), as it reduces the need to resend lost or corrupted packets by enabling the receiver to reconstruct data from available information. In some implementations, the system selectively integrates these reliability mechanisms (e.g., based on real-time device conditions and network stability) to help provide data integrity while helping conserve computing, storage, and/or networking resources.

In some embodiments, the system uses adaptive frame segmentation to break large messages (e.g., WebSocket messages) into smaller frames based on a condition score (e.g., of a device or server), thereby easing processing demands and smoothing data flow when resources are constrained. In some implementations, the system uses this segmentation to allow for incremental transmission in low-resource environments (e.g., while larger frames are sent when conditions improve), thereby optimizing transmission speed. In some embodiments, the system divides messages (e.g., WebSocket messages, a complete set of data exchanged between the client and server) into multiple frames (e.g., a discrete unit of data within a larger message) to facilitate more manageable data transfer. In some implementations, the system generates a plurality of frames for a single message, each frame representing a fragment of the full message, and these frames are reassembled by the receiver to reconstruct the message in its entirety. In some embodiments, the system uses messages (e.g., WebSocket messages) as the main unit of communication (e.g., because they can contain various types of data, such as, for example, text, binary data, or structured information like JSON). In some implementations, to optimize the transmission of larger messages, the system (e.g., WebSocket, system 100) allows messages to be split into smaller chunks, or frames, which are sent sequentially over the connection. In some embodiments, the system uses segmentation when dealing with large data transmissions, as it breaks the message into smaller, more manageable parts, thereby improving efficiency.

In some embodiments, when frames reach the receiving endpoint, the receiver collects the frames and reassembles the original message before delivering the message to the application layer. In some implementations, the system uses this process to seamlessly provide information to the application, which ultimately receives the full message as though it had been transmitted in one piece. In some embodiments, by segmenting messages into frames, the system (e.g., WebSocket, system 100) handles fragmented messages in a way that enables continuous data flow, avoids large data bursts, and supports efficient management of limited resources. In some implementations, the system uses this framing capability to allow the system to adapt to varying transmission needs by breaking down data into segments that suit, e.g., the application's requirements and/or the network's capacity.

In some embodiments, when the primary device experiences relatively low resources, such as, for example, low battery (e.g., below a threshold, such as, for example, 40% or 50%) or poor network stability (e.g., below a threshold upload or download speed), the system allows the primary device to offload data retrieval to a nearby secondary device (e.g., the secondary device identified based on network connection, proximity detection, Bluetooth detection, or any other suitable method or combination thereof). In some implementations, the system identifies a secondary device to be used as a proxy based on physical proximity or network proximity (e.g., on the same LAN). For example, in some embodiments, when a phone is receiving a stream of a show via a streaming application and determines that the phone is resource-limited, the system identifies a TV on the same LAN that has the streaming application installed and initiates a proxy connection through the TV. In some implementations, the primary device sends a support request to the server (e.g., WebSocket server), which generates a unique synchronization identifier for secure coordination between the two devices. In some embodiments, the primary device shares this identifier with the secondary device over a low-energy connection, such as, for example, Bluetooth Low Energy (BLE), signaling it to take over the communication (e.g., WebSocket communication) on its behalf. In some implementations, the secondary device fetches data from the server (e.g., by using a connection suitable for a resource-rich environment, such as cellular) and subsequently relays the fetched data to the primary device (e.g., over the BLE connection). In some embodiments, the system uses this method to conserve energy by allowing the primary device to remain connected on a low-power channel while the secondary device handles high-energy data retrieval. In some implementations, when the condition score of the primary device improves (e.g., due to charging the battery), the primary device resumes direct communication, thereby allowing the secondary device to stop proxying.

In some embodiments, the system uses presence detection to adjust update frequency and connection settings when the user is actively present, thereby ensuring timely information delivery while minimizing data flow during absence. In some implementations, the system uses device proximity to determine if a device of the user is close enough to a relevant endpoint, such as, for example, a smart TV or secondary device, thereby enabling seamless interactions such as pausing or resuming data flow depending on the proximity of the user or the device of the user. In some embodiments, the system uses engagement-level monitoring to capture an interaction frequency of the user with the device or app, thereby allowing the system to prioritize real-time updates and reduce non-critical data transfers (e.g., notifications regarding a sports score, or a marketing email notification of receipt) during periods of inactivity.

As shown in FIG. 1, in some embodiments, system 100 comprises user device 102 and application server 104. In some implementations, user device 102 receives a user input to establish a communication channel over a network with a second device (e.g., application server 104). In some embodiments, user device 102 receives a user input to launch an application (e.g., App 1, App 2, App 3, App 4), such as, for example, a web browser, a social media application (e.g., Instagram, TikTok), a content streaming application (e.g., Netflix, Hulu), a health application (e.g., Strava, FitBit), a stock application, a shopping application (e.g., Home Depot, Walmart), a messaging service, a sensor network, a wearable application, an interactive consumer application, or any other suitable application (e.g., that triggers a request to establish a communication channel with a server of the application). In some implementations, upon receiving a user input to launch an application (e.g., App 1), user device 102 transmits a request to application server 104 to establish a communication channel. In some embodiments, user device 102 transmits the request to establish a communication channel to initiate handshake 106. In some embodiments, user device 102 transmits the request to establish a communication channel indicating a current resource environment of user device 102, such as the current battery level, network bandwidth, latency, and/or CPU/GPU usage (e.g., parameters indicative of one or more resources available to user device 102). In some implementations, user device 102 calculates a condition score indicating a current resource environment of user device 102 (e.g., as further described below). In some embodiments, application server 104 receives the request from user device 102 indicating the current resource environment of user device 102 and calculates a condition score of user device 102.

In some implementations, application server 104 and/or user device 102 engage to establish handshake 106 (e.g., user device 102 transmits a request to establish a connection, application server transmits a response to the request, and user device 102 transmits a confirmation to finalize the connection). In some embodiments, application server 104 and user device 102 establish handshake 106 as a low-power handshake, a low-power WebSocket handshake, a WebSocket handshake, an adjustable handshake, or any other suitable handshake. In some implementations, application server 104 and user device 102 establish handshake 106 based on the resource environment of user device 102 (e.g., based on the calculated condition score of user device 102). In some embodiments, application server 104 and user device 102 establish handshake 106 based on a resource environment of application server 104 (e.g., based on a condition score of application server 104 that is based on CPU/GPU usage, RAM usage, available bandwidth, latency, and/or network congestion of application server 104). In some implementations, application server 104 and user device 102 determine (e.g., via handshake 106) initial communication protocols (e.g., based on the resource environment of user device 102 and/or application server 104). In some embodiments, application server 104 and user device 102 determine (e.g., based on a resource environment of user device 102 and/or application server 104) a protocol for the communication channel, such as, for example, a keep-alive message interval (e.g., every 30 seconds), a batch size for message transmittal (e.g., batches of five messages), a transmission interval (e.g., a transmission every 100 ms), a compression level (e.g., none, low, high), an error-resilient transmission mode (e.g., FEC), a frame segmentation protocol (e.g., a maximum frame size to be transmitted), a device-assisted protocol (e.g., how/when to establish a proxy connection between a second device and application server 104), a presence protocol, or any other suitable communication protocol (e.g., attributes of control data). In some implementations, application server 104 and/or user device 102 determine specific aspects of the protocol based on specific aspects of the resource environment (e.g., determine a keep-alive message interval based on the battery level of user device 102 and determines a compression level based on GPU/CPU usage of user device 102 and/or application server 104).

In some embodiments, application server 104 and user device 102 transmit control data via the established communication path. For example, in some implementations, application server 104 and user device 102 transmit requests, responses, acknowledgements, or any other messages that comprise control data (e.g., indicate communication protocol(s) to be used). In some embodiments, application server 104 and user device 102 transmit control data to establish a communication channel to be operated under specified communication protocol(s). In some implementations, upon application server 104 and user device 102 establishing handshake 106 (e.g., establishing communication protocols and a communication channel to be used), application server 104 transmits data 113 (e.g., control data such as updates to an aspect of the communication protocol, content data such as mp4 files) to user device 102 that causes user device 102 to generate for display user interface 108. For example, in some embodiments, when application server 104 comprises a server of a video-streaming application (e.g., YouTube), user device 102 generates user interface 108 (e.g., based on data 113 received from application server 104) having three listed videos (e.g., “Elephant playing in water,” “Squirrel hiding a nut,” and “Monkey eating a banana”) and each video having a respective animated thumbnail (e.g., animated thumbnail 109 of a three-second snippet of an elephant spraying water from its trunk).

In some embodiments, application server 104 transmits data 113 to user device 102 based on the established communication parameters (e.g., as established during handshake 106) and/or based on a resource environment of user device 102 and/or application server 104 (e.g., based on a respective condition score of user device 102 and/or application server 104). For example, in some implementations, application server 104 transmits (e.g., based on the established communication protocols and/or a respective condition score of user device 102 and/or application server 104) data 113 comprising animated thumbnail 109 (e.g., rather than a static thumbnail or no thumbnail). In some embodiments, application server 104 and/or user device 102 transmit data 113 based on user device 102 being in a resource-rich environment (e.g., having a high battery level as indicated by battery indicator 110 and having a strong network connection as indicated by network indicator 112). In some embodiments, user device 102 transmits data 113 (e.g., control data, acknowledgements) to application server 104. For example, in some implementations, user device 102 transmits data 113 to application server 104 on a regular schedule (e.g., transmits a keep-alive message to application server 104 based on the determined keep-alive interval that was established during handshake 106).

In some embodiments, user device 102 and/or application server 104 may continuously monitor their respective resource environments (e.g., battery level, CPU/GPU usage, latency, or any other suitable resource parameter) and optionally report an indication of their respective resource environment to the other device. For example, in some embodiments, user device 102 transmits an indication of a full battery and a strong network connection (e.g., four bars) to application server 104. In some implementations, user device 102 and/or application server 104 identify a current resource range (e.g., high, moderate, low, critical) corresponding to respective communication protocols. For example, in some embodiments, when in a high resource range (e.g., a condition score of user device 102 and/or application server 104 is 0.9), user device 102 and/or application server 104 opt to use a small keep-alive interval (e.g., transmit a keep-alive message every 15 seconds), opt to prioritize high-speed transmission over error-resilient messaging, and/or opt to transmit animated thumbnail 109 (e.g., instead of a stagnant thumbnail or no thumbnail). Further, in some implementations, when in a low resource range (e.g., a condition score is 0.25), user device 102 and/or application server 104 opt to use a large keep-alive interval (e.g., transmit a keep-alive message every 115 seconds), opt to prioritize error-resilient messaging over high-speed transmission (e.g., use FEC), and/or opt out of transmitting a thumbnail (e.g., non-critical data).

In some implementations, upon user device 102 determining that its resource environment has entered a new range (e.g., has dropped from high to moderate), user device 102 transmits data 113 (e.g., control data) to application server 104 indicating the change in resource status and/or requesting a change to be made to the communication protocol (e.g., extend the keep-alive interval, increase compression level, update an attribute of the control data). In some embodiments, upon receiving an indication of the resource environment of user device 102 (e.g., data indicating a moderate condition score and/or specific measured parameters such as a moderate battery level or moderate network connection), application server 104 determines an adjustment to be made to the communication protocol (e.g., based on the specific measured parameters and/or based on the current resource range). In some implementations, application server 104 transmits data 119 (e.g., control data such as updates to an aspect of the communication protocol, content data such as text files) to user device 102 that causes user device 102 to generate for display user interface 114. For example, in some embodiments, when application server 104 comprises a server of a video-streaming application (e.g., YouTube), user device 102 generates user interface 114 (e.g., based on data 119 received from application server 104) having three listed videos (e.g., “Elephant playing in water,” “Squirrel hiding a nut,” and “Monkey eating a banana”) and each video having a respective stagnant thumbnail (e.g., thumbnail 115 of a picture of an elephant).

In some embodiments, application server 104 transmits data 119 to user device 102 based on the established communication protocols (e.g., as established based on data 113 indicating that the resource environment of user device 102 has dropped). For example, in some implementations, application server 104 transmits (e.g., based on the established communication protocols and/or a respective condition score of user device 102 and/or application server 104) data 119 comprising thumbnail 115 (e.g., rather than an animated thumbnail or no thumbnail). In some embodiments, application server 104 and/or user device 102 transmit data 119 based on user device 102 being in a moderate resource environment (e.g., having a medium battery level as indicated by battery indicator 116 and having a moderate network connection as indicated by network indicator 118). In some embodiments, user device 102 transmits data 119 (e.g., control data, acknowledgements, keep-alive messages) to application server 104 (e.g., in accordance with the adjusted communication protocol).

In some embodiments, upon user device 102 determining that its resource environment has entered a new range (e.g., has dropped from moderate to low), user device transmits data 119 (e.g., control data) to application server 104 indicating the change in resource status and/or requesting a change to be made to the communication protocol (e.g., extend the keep-alive interval, increase compression level). In some embodiments, upon receiving an indication of the resource environment of user device 102 (e.g., data indicating a low condition score and/or specific measured parameters such as low battery level or a weak network connection), application server 104 determines an adjustment to be made to the communication protocol (e.g., based on the specific measured parameters and/or based on the current resource range). In some implementations, application server 104 transmits data 125 (e.g., control data such as updates to an aspect of the communication protocol, content data such as text files) to user device 102 that causes user device 102 to generate for display user interface 120. For example, in some embodiments, when application server 104 comprises a server of a video-streaming application (e.g., YouTube), user device 102 generates user interface 120 (e.g., based on data 125 received from application server 104) having three listed videos (e.g., “Elephant playing in water,” “Squirrel hiding a nut,” and “Monkey eating a banana”) and no thumbnail (e.g., due to the low resource environment of user device 102).

In some embodiments, application server 104 transmits data 125 to user device 102 based on the established communication protocols (e.g., as established based on data 119 indicating that the resource environment of user device 102 has become further restricted). For example, in some implementations, application server 104 transmits (e.g., based on the established communication protocols and/or a respective condition score of user device 102 and/or application server 104) data 125 (e.g., comprising text files indicating the title of videos but no thumbnail), to user device 102 to cause user device 102 to generate for display user interface 120. In some embodiments, application server 104 and/or user device 102 transmit data 125 based on user device 102 being in a low/critical resource environment (e.g., having a low battery level as indicated by battery indicator 122 and having a low network connection as indicated by network indicator 124). In some embodiments, user device 102 transmits data 125 (e.g., control data, acknowledgements, keep-alive messages) to application server 104 (e.g., in accordance with the adjusted communication protocol). In some implementations, upon user device 102 determining that its resource environment has entered a new range (e.g., has increased from low to moderate), user device transmits data (e.g., control data) to application server 104 indicating the change in resource status and/or requesting a change to be made to the communication protocol (e.g., extend the keep-alive interval, increase compression level). For example, in some embodiments, based on receiving data indicating that user device 102 has entered a moderate resource environment, application server 104 transmits data (e.g., data 119 instead of data 125) to user device 102 to cause user device 102 to generate for display a user interface (e.g., user interface 114) that is based on the moderate resource environment of user device 102 (e.g., despite user device 102 previously being in a low-resource environment causing user interface 120 to be generated).

In some embodiments, user device 102 and/or application server 104 determine a communication protocol and/or adjustments to be made to the communication protocol based on user preferences and/or settings. For example, in some implementations, when user preferences/settings indicate that a user prefers to always prioritize saving resources (e.g., even when in a resource rich environment), user device 102 and/or application server 104 cause the communication protocol to consistently be in a conservative mode (e.g., high keep-alive interval, high compression rate, using error-resilient transmission mode(s), high batch size, high transmission interval), regardless of changes in resource environment. Further, in some embodiments, user device 102 and/or application server 104 cause the communication protocol to remain in a power-saving state whenever, e.g., user device 102 is not plugged in to a charger. In some implementations, user device 102 provides an interface for manually adjusting communication protocols (e.g., toggling various power-saving functionalities on and off and/or setting a specific level or preference for various power-saving functionalities). In some embodiments, when user preferences/settings indicate that a user prefers to receive all available data (e.g., animated thumbnail 109 rather than stagnant thumbnail 115) but is happy to experience transmission speed delays, user device 102 and/or application server 104 cause the communication protocol to save power/energy at the expense of transmission speed (e.g., by using error-resilient transmission methods), but not at the expense of minimizing data transmission. In some implementations, when user device 102 and/or application server 104 determine a user prefers to save energy/power by receiving less data (e.g., no thumbnails) but not by compromising on transmission speeds (e.g., regardless of a resource environment of user device 102), user device 102 and/or application server 104 cause the communication protocol to allow for high transmission speeds (e.g., by not using error-resilient transmission methods) while minimizing data transmission (e.g., using a high keep-alive interval).

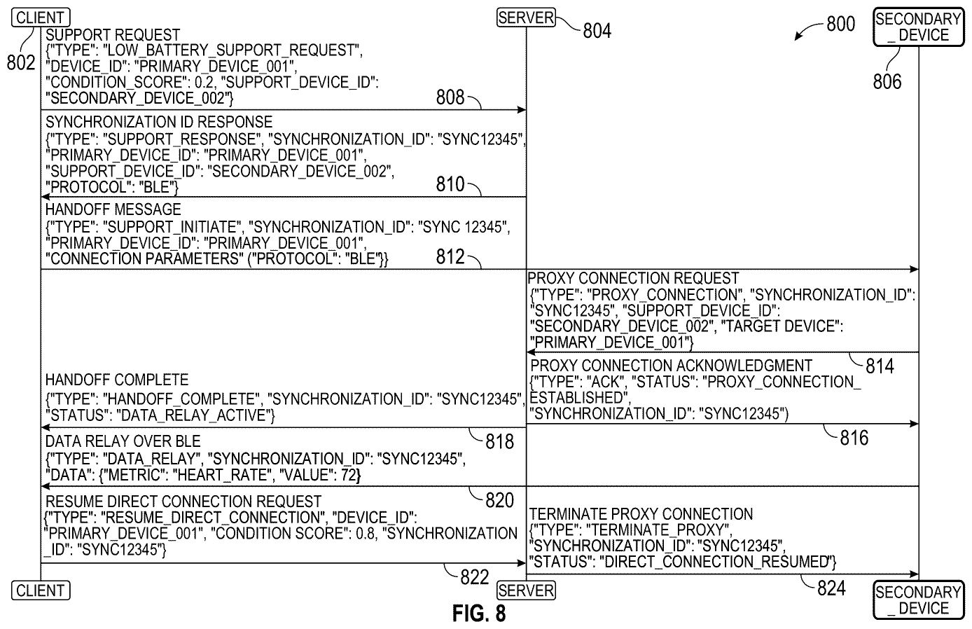

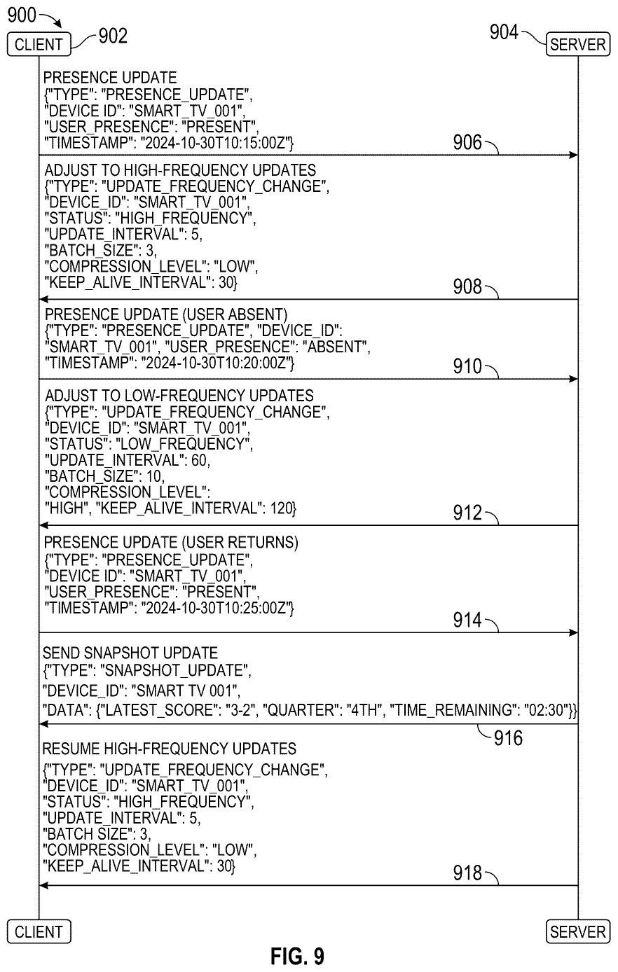

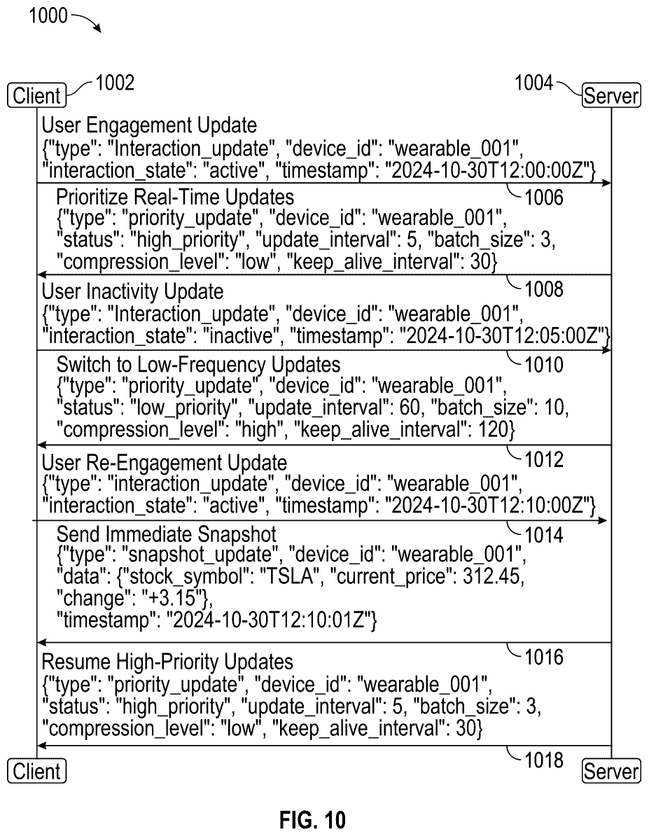

In some embodiments, when user device 102 and/or application server 104 determines that user device 102 is in a low and/or critical resource environment (e.g., such as a low battery and low network connection as depicted in user interface 120), user device 102 and/or application server 104 identify a second device to establish a proxy connection with application server 104 and transmit data received from application server 104 to user device 102 over, for example, BLE (e.g., as further described in regard to FIG. 8). In some implementations, user device 102 and/or a second device (e.g., in the proximity of user device 102) determine an engagement status of a user of user device 102 (e.g., based on a camera, a microphone, a movement sensor, or any other suitable method) and modify a connection protocol (e.g., used for the communication channel used by user device 102 and application server 104), as further described in regard to FIGS. 9 and 10. In some embodiments, system 100 identifies the second device based one or more user accounts associated with the first device being associated with the second device. For example, in some implementations, when user device 102 is signed into a respective user account, system 100 identifies one or more devices signed into the respective user account and select a device signed into that account to be used for a proxy connection. In some embodiments, system 100 selects the second device to be used for a proxy connection based on user accounts associated with the device and/or proximity (e.g., determined based on Bluetooth connection, shared Wi-Fi connection, or any other suitable method).

In some embodiments, the RTME tracks relevant device parameters, such as, for example, battery life, CPU/GPU load, and/or network bandwidth, at regular intervals. In some implementations, the system (e.g., system 100) uses these parameters to calculate a condition score that reflects the overall device and network environment. In some embodiments, the system periodically updates the condition score to accommodate any change in device status or resource availability. For example, a low battery level would assign greater weight to energy-saving adjustments, while limited network bandwidth could increase the importance of batching and compression within, e.g., WebSocket messages. In some embodiments, the system computes the condition score(S) by summing weighted normalized device parameters. In some implementations, using device-specific data such as battery level, network bandwidth, latency, and CPU/GPU usage, the system normalizes each parameter and multiplies each normalized parameter by its respective weight to reflect each parameter's current impact on energy efficiency. For example, in some embodiments, the system calculates the condition score using the equation: S=W_{B}*N_{B}+W_{N}*N_{N}+W_{L}*N_{L}+W_{J}*N_{J}+W_{C}*N_{C}, where each weight (e.g., W_{B}, W_{N}, W_{L}, W_{J}, W_{C}) is dynamically adjusted based on current conditions. The symbol designates the mathematic operation of multiplication and the subscripts designate respective parameters (e.g., B=battery level, N=network bandwidth, L=latency, J=jitter, C=CPU/GPU usage). In some embodiments, system 100 uses an application-dependent score formula. For example, in some implementations, the system assigns weights to specific parameters based on the application (e.g., the application of application server 104), such as higher weights for network performance metrics and lower weights for device metrics (e.g., battery level, CPU usage, GPU usage).

For example, in some embodiments, when the battery level is 20%, the system normalizes the battery level to 0.2 (e.g., N_{B}=0.2); when the network bandwidth is 5 Mbps (e.g., out of 100 Mbps), the system normalizes the network bandwidth to 0.05 (e.g., N_{N}=0/05); when the latency is 150 ms (e.g., when 300 ms is the acceptable maximum), the system normalizes the latency to 0.5 (e.g., N_{L}=0.5); and when the CPU/GPU usage is 50%, the system normalizes the CPU/GPU usage to 0.5 (e.g., N_{C}=0.5). In some implementations, to calculate the condition score, the system uses the normalized values and assigns weights to each parameter. For example, in some embodiments, when the weight for battery level (e.g., W_{B}) is 0.4, the weight for network bandwidth (e.g., W_{N}) is 0.3, the weight for latency (e.g., W_{L}) is 0.2, and the weight for CPU/GPU Usage (e.g., W_{C}) is 0.1, the system calculates the battery level using the equation S=(W_{B}*Battery Level)+ (W_{N}*Network Bandwidth)+ (W_{L}*Latency)+ (W_{C}*CPU/GPU Usage), (e.g., S=(0.4*0.2)+ (0.3*0.05)+ (0.2*0.5)+ (0.1*0.5)=0.08+0.015+0.1+0.05=0.245). In a non-limiting example, the system calculates the condition score to be 0.245, reflecting the current resource state of the device. In some embodiments, such combined (e.g., normalized) condition score for a plurality of parameters is compared to a threshold to determine whether to update at least one attribute of control data, and/or scores for respective parameters may be compared to respective thresholds for the parameters.

In some embodiments, when the condition score indicates limited resources, the system triggers more aggressive energy-saving measures such as, for example, adaptive keep-alive frequency reduction, low-power handshake initialization, and intelligent frame batching. In some implementations, the system makes these adjustments to ensure that the WebSocket protocol dynamically aligns with device capabilities, thereby enhancing both energy efficiency and connectivity. In some embodiments, during the initial WebSocket handshake, the system initiates a low-power handshake protocol to allow the client and server to negotiate energy-efficient communication settings throughout the duration of the connection. In some implementations, the system sets a higher compression level, limits the resolution and/or payload of initial messages, and extends connection timeouts. In some embodiments, by establishing energy-saving conditions at the connection's outset, the system uses the low-power handshake to immediately optimize resource usage e.g., tailored for the power limitations of the client device.

In some embodiments, the system establishes the supported energy efficient (e.g., EE) handshake using the following request:
GET/chat HTTP/1.1
Host: server.example.com
Upgrade: websocket
Connection: Upgrade
Sec-WebSocket-Key: dGhlIHNhbXBsZSBub25jZQ==
Sec-WebSocket-Version: 13
Sec-WebSocket-Protocol: chat, superchat
Sec-WebSocket-Extensions: permessage-deflate
X-EE-WS-Support: low-power, adaptive-keepalive, frame-batching
X-EE-WS-Condition-Score: 0.3; indicating low battery/poor network

In some embodiments, the system transmits the message portion “X-EE-WS-Condition-Score: 0.3” to indicate low battery and/or poor network. In some implementations, the system uses “X-EE-WS-Support” to list the supported energy-efficient features, such as, for example, “low-power” for low-power handshake, “adaptive-keepalive” for adaptive keep-alive intervals, and “frame-batching” for message batching. In some embodiments, the system uses “X-EE-WS-Condition-Score” to provide a numerical number reflecting the current energy condition of the client device (e.g., where a lower score indicates limited resources, prompting more aggressive energy-saving behavior).

In some embodiments, the server acknowledges the request, thereby confirming the WebSocket upgrade, and responds with headers indicating which energy-efficient features it agrees to enable based on the client's request and available server support. In some embodiments, when the client's condition score (e.g., 0.3) indicates a low resource state, the server responds with extended keep-alive intervals and message batching parameters designed to conserve energy, such as, for example, the following header:
HTTP/1.1 101 Switching Protocols Upgrade: websocket
Connection: Upgrade
Sec-WebSocket-Accept: s3pPLMBiTxaQ9kYGzzhZRbK+x00=
Sec-WebSocket-Extensions: permessage-deflate
X-EE-WS-Accept: low-power, adaptive-keepalive
X-EE-WS-Keepalive-Interval: 120; 120 seconds for keep-alive interval
X-EE-WS-Batch-Size: 5; Batch size of 5 messages per transmission
   In some embodiments, the system transmits “X-EE-WS-Keepalive-Interval: 120” to indicate that the keep-alive interval is to be 120 seconds and transmits “X-EE-WS-Batch-Size: 5” to indicate that a batch size of five messages per transmission is to be used. In some implementations, the server uses “X-EE-WS-Accept” to confirm which energy-efficient features are accepted. In some embodiments, the server supports “low-power” and “adaptive-keepalive” but does not support “frame-batching,” so “X-EE-WS-Batch-Size” is not included. In some embodiments, the server uses “X-EE-WS-Keepalive-Interval” to set a specific keep-alive interval in seconds based on the condition score and device status. In some implementations, the server uses “X-EE-WS-Batch-Size” to indicate the number of messages to batch before a transmission. In some embodiments, when the “X-EE-WS-Batch-Size” is omitted, the system uses standard real-time transmission as a default protocol.

In some embodiments, once the handshake is complete, the client and server begin communication using the agreed-upon settings. For example, in some implementations, the client adjusts keep-alive messages to the specified 120-second interval. In some embodiments, when the server sends an initial message with a “low-power” indicator, the client applies lower processing requirements for the session, such as, for example, minimal data compression or longer timeout intervals. In some implementations, the system optionally includes the above-referenced custom headers beginning with X-EE-WS—that indicate additional settings for energy-saving purposes. In some embodiments, traditional WebSocket servers or clients that don't recognize these features ignore the custom headers, ensuring backward compatibility.

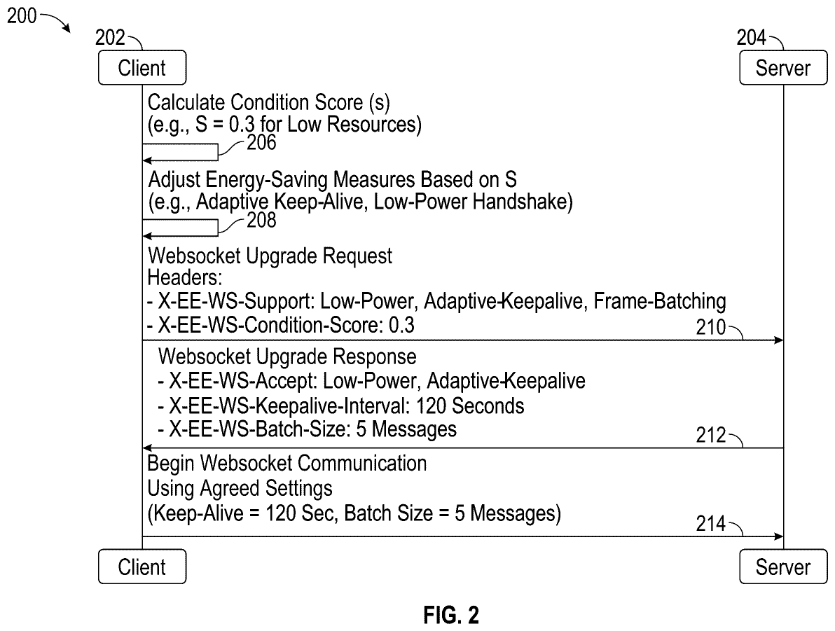

FIG. 2 is a sequence diagram that depicts process 200 comprising client 202 and server 204, in accordance with some embodiments of this disclosure. Process 200 may be implemented at least in part by, for example, system 100 of FIG. 1. In some implementations, client 202 is user device 102 of FIG. 1, and/or server 204 is application server 104 of FIG. 1. In some embodiments, client 202 and server 204 have established a WebSocket connection (e.g., by using a low-power handshake such as handshake 106 of FIG. 1). In some implementations, at 206, client 202 calculates a condition score (e.g., S) to indicate its current resource environment. In some embodiments, client 202 continuously monitors its available resources and regularly calculates S. In some implementations, client 202 identifies when a measured resource parameter and/or S drop below a threshold level. In some embodiments, client 202 calculates a low score (e.g., 0.3) when resources are limited and a high resource score (e.g., 0.9) when resources are plentiful. In some implementations, client 202 transmits an indication of resource parameter statuses to server 204 and server 204 calculates a condition score. In some embodiments, client 202, at 208, adjusts energy-saving measure based on S. In some implementations, client 202 adjusts energy-saving measures (e.g., adaptive keep-alive, low-power handshake) based on the measured resources available to client 202 (e.g., adjusts a first energy-saving measure based on a first measured resource parameter and adjusts a second energy-saving measure based on a second measured resource parameter). In some embodiments, client 202 transmits an indication of resource parameter statuses to server 204 and server 204 determines adjustments to make. In some implementations, server 204 adjusts specific energy-saving measures based on specific resource parameters.

In some implementations, at 210, client 202 transmits, to server 204, a “WebSocket Upgrade Request” having the headers “X-EE-WS-Accept: low-power, adaptive-keepalive, frame-batching” and “X-EE-WS-Condition-Score: 0.3.” In some embodiments, client 202 transmits a “WebSocket Upgrade Request” having any number of headers to communicate any relevant information to server 204 (e.g., specific headers for specific parameters). In some embodiments, at 212, server 204 transmits, to client 202, a “WebSocket Upgrade Response” having the headers “X-EE-WS-Accept: low-power, adaptive-keepalive,” “X-EE-WS-Keepalive-Interval: 120 seconds,” and “X-EE-WS-Batch-Size: 5 message.” In some implementations, server 204 transmits a “WebSocket Upgrade Response” having any number of headers to communicate any relevant information to client 202. (e.g., to acknowledge each change requested by client 202). In some embodiments, client 202, at 214, begins the WebSocket communication using the agreed settings as received from server 204 (e.g., keep-alive=120 sec, batch size=5 messages).

In some embodiments, the system uses an adaptive keep-alive feature to alter the interval of keep-alive messages sent to maintain the connection (e.g., WebSocket connection). In some implementations, when the condition score is low, indicating resource constraints, the system reduces the frequency of these signals to conserve energy. In some embodiments, when the device returns to a higher energy state, the system automatically shortens the keep-alive interval to support standard connectivity. In some implementations, the adaptive keep-alive feature is particularly useful for minimizing energy usage during idle periods. In some embodiments, the system enables the adaptive keep-alive feature by linking the interval of keep-alive messages to the condition score generated by the client's monitoring system. In some implementations, as the condition score decreases (e.g., indicating resource limitations), the system extends the keep-alive interval to reduce unnecessary transmissions. In some embodiments, when the condition score improves, the system shortens the interval to ensure the connection remains responsive.

In some embodiments, the system structures a relationship (e.g., symbiotic) between the adaptive keep-alive feature and the condition score. In some implementations, when there is a high condition score (e.g., 0.8-1.0) indicating that the device is in optimal condition with sufficient battery and network resources, the system configures keep-alive messages to be sent every 30 seconds, ensuring high connection responsiveness. In some embodiments, when there is a moderate condition score (e.g., 0.5-0.79) indicating that resources are moderately constrained, the system configures the keep-alive interval to be set to 60 seconds to balance connectivity with some energy conservation. In some implementations, when there is a low condition score (e.g., 0.3-0.49) indicating that the device has limited resources (e.g., such as low battery or restricted bandwidth), the system extends the keep-alive interval to 120 seconds to prioritize energy conservation. In some embodiments, when there is a critical condition score (e.g., below 0.3) indicating that the device is in critical resource mode (e.g., with very low battery or severely constrained network), the system configures the keep-alive interval to be set to 180 seconds or more, thereby significantly reducing transmission frequency and minimizing energy use.

In some embodiments, when the connection (e.g., WebSocket connection) is established, the system (e.g., by the client device) calculates the initial condition score of the client. In some implementations, the client communicates to the server the initial condition score during the handshake via a custom header (e.g., X-EE-WS-Condition-Score). In some embodiments, the server assigns the appropriate keep-alive interval based on the initial condition score received from the client. In some implementations, the client continuously monitors its condition in real time. In some embodiments, when the condition score falls below a certain threshold, the system (e.g., by the client) updates the server by sending a frame or a message tagged with a new condition score. In some implementations, the system includes the update to the condition score in, e.g., a regular WebSocket message or, optionally, a control message dedicated to EE adjustments. In some embodiments, upon receiving the updated condition score, the server adjusts its keep-alive response interval accordingly (e.g., according to the established relationship between the keep-alive response feature and the condition score). For example, in some implementations, when the condition score changes from moderate (e.g., 0.5) to low (e.g., 0.3), the system increases the keep-alive interval from 60 seconds to 120 seconds. In some embodiments, when the condition score improves (e.g., from low to moderate), the system shortens the keep-alive interval to enable more frequent connection validation.

In some embodiments, the system (e.g., by the client) transmits (e.g., to the server) a condition score update such as, for example:

```
{
  “type”: “EE_Condition_Update”,
  “condition_score”: 0.35,
  “suggested_keepalive_interval”: 120
}
```

In some implementations, when either the client or server fails to support or recognize the “EE keep-alive feature,” the system uses a default fixed keep-alive interval (e.g., as per standard WebSocket behavior), ensuring connection reliability even without adaptive adjustments.

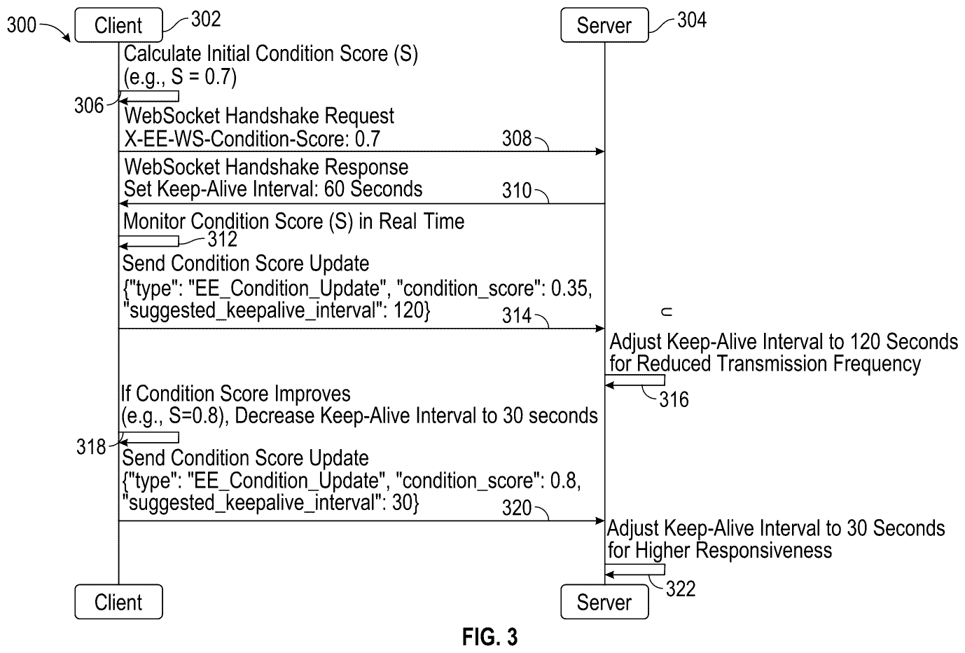

FIG. 3 is a sequence diagram that depicts process 300 comprising client 302 and server 304, in accordance with some embodiments of this disclosure. Process 300 may be implemented at least in part by, for example, system 100 of FIG. 1. In some implementations, client 302 is user device 102 of FIG. 1, and/or server 304 is application server 104 of FIG. 1. In some embodiments, at 306, client 302 calculates an initial condition score (e.g., S). In some implementations, client 302 calculates a moderate condition score (e.g., 0.7). In some embodiments, at 308, client 302 transmits, to server 304, a “WebSocket Handshake Request” indicating the calculated condition score (e.g., comprising the message “X-EE-WS-Condition-Score: 0.7”). In some implementations, at 310, server 304 transmits, to client 302, a “WebSocket Handshake Response” indicating an aspect of a communication protocol to be used (e.g., comprising the message “Set Keep-Alive Interval: 60 seconds.” In some embodiments, server 304 determines an aspect of a communication protocol to be used based on the received request (e.g., that S is 0.7). In some implementations, at 312, client 302 monitors S in real time (e.g., continuously monitors measured resource parameters and updates a calculated condition score based on the changing resource parameters).

In some embodiments, at 314, client 302 sends (e.g., transmits), to server 304, a condition score update comprising the most recently calculated condition score (e.g., that reflects the current resource conditions of client 302) and, optionally, a suggested modification (e.g., update to) the communication protocol. For example, in some implementations, client 302 transmits the message “{“type”: EE_Condition_Update”, “condition_score”: 0.35, “suggested_keepalive_interval”: 120}.” In some embodiments, at 316, server 304 adjusts (e.g., increases) the keep-alive interval to 120 seconds, thereby reducing transmission frequency. In some implementations, at 318, client 302 determines if the condition score improves (e.g., increases from 0.35 to 0.8) and identifies a keep-alive interval suitable for the improved condition score (e.g., 30 seconds). In some embodiments, at 320, client 302 transmits, to server 304, a condition score update comprising the most recently calculated condition score (e.g., that reflects the current resource conditions of client 302) and, optionally, a suggested modification (e.g., update to) the communication protocol. In some implementations, client 302 transmits the message “{“type”: EE_Condition_Update”, “condition_score”: 0.8, “suggested_keepalive_interval”: 30}.” In some embodiments, at 322, server 304 adjusts (e.g., decreases) the keep-alive interval to 30 seconds, thereby increasing responsiveness.

In some embodiments, the system reduces transmission overhead by using a binary encoding scheme for recurring parameter updates, with adjustments based on the device's real-time condition score. In some implementations, when the condition score indicates limited resources, such as, for example, low battery or constrained network conditions, the system enters a low-power mode and transitions to binary encoding for greater efficiency. In some embodiments, during the initial handshake, or when a low-power state is triggered, the device sends a structured JSON schema to the server, the structure JSON schema serving as a reference for the server for interpreting subsequent binary-encoded messages. In some implementations, the device (e.g., client device) transmits this schema comprising the meanings of various parameters and their corresponding bit lengths, thereby establishing a shared structure for both the client and server.

In some embodiments, following the initial schema transmission and receipt, the client and server communicate using compact binary messages that adhere to the predefined structure, significantly reducing data size and transmission frequency. For example, in some implementations, a health monitoring application on a wearable device (e.g., where continuous updates for metrics such as, for example, heart rate, oxygen levels, or activity counts are necessary) designates specific bit lengths for each parameter within the schema. In some embodiments, when the condition score signals limited resources, the system streamlines each message to contain only binary values aligned with the structured (e.g., JSON) schema, thereby minimizing data transmission size.

In some embodiments, when the device is a Fitbit-like step-tracking device that monitors metrics such as, for example, steps, heart rate, and battery level, the device sends the following structured JSON schema and corresponding binary message to the server during the handshake to define the meanings and bit-lengths of each parameter:

```
{
  “type”: “schema_definition”,
  “schema_id”: “fitbit_low_power_mode”,
  “parameters”: [
    {
      “name”: “steps”,
      “bit_length”: 16,
      “description”: “Total step count”
    },
    {
      “name”: “heart_rate”,
      “bit_length”: 8,
      “description”: “Current heart rate in bpm” },
    {
      “name”: “battery_level”,
      “bit_length”: 8,
      “description”: “Battery level percentage” },
    {
      “name”: “timestamp”,
      “bit_length”: 32,
      “description”: “Timestamp of the data” }
  ]
}
```

In some embodiments, following the transmission of the above structured JSON schema and corresponding binary message, the device sends only the binary-encoded messages that adhere to this schema when operating in a low-power mode based on a low condition score.

For example, in some embodiments, when the device intends to send data indicating 10,000 steps, a 72 bpm heart rate, an 85% battery level, and a 1,698,489,673 timestamp (e.g., in epoch time), the device encodes the respective values into binary according to an established schema (e.g., the above structured JSON schema). In some embodiments, the device encodes the 10,000 steps at 16 bits to determine 00100111 00010000 as the binary message to be transmitted (e.g., the binary representation of 10,000), the 72 bpm heart rate at 8 bits to determine 01001000 as the binary message to be transmitted (e.g., binary representation of 72), the 85% battery level at 8 bits to determine 01010101 as the binary message to be transmitted (e.g., binary representation of 85), and the 1,698,489,673 timestamp at 32 bits to determine 01100101 01000011 11011000 11010001 as the binary message to be transmitted (e.g., binary representation of 1,698,489,673). Further, in some implementations, the device (e.g., a Fitbit, a smartwatch) transmits the binary message “00100111 00010000 01001000 01010101 01100101 01000011 11011000 11010001” which is 48 bits total, thereby saving bandwidth and conserving power on the device (e.g., as opposed to sending the equivalent data in JSON format).

In some embodiments, the system batches multiple messages (e.g., WebSocket messages) into a single transmission batch, thereby reducing the frequency of network interface activations. In some implementations, the system uses message batching for devices with constrained resources, as it conserves power by minimizing transmissions. In some embodiments, the system dynamically adjusts batch size and transmission frequency according to the real-time condition score of the device, thereby ensuring an optimal balance between energy savings and communication latency.

In some embodiments, as the condition score decreases (e.g., indicating resource limitations), the system increases batch size and transmission intervals to conserve power. In some implementations, when resources improve, the system decreases batch sizes and decreases transmission intervals (e.g., transmissions become more frequent) to maintain low-latency communication. For instance, in some embodiments, when the condition score is high (e.g., between 0.8 and 1.0), indicating that the device has ample resources, the system minimizes its use of batching, allowing near real-time messaging. In some implementations, the system enables near real-time messaging by using a small batch size and short transmission intervals (e.g., 100 ms). In some embodiments, when there is a moderate condition score (e.g., 0.5 to 0.79), indicating that resources are more limited, the system batches messages in groups of 3 to 5 and sends the batches every 500 ms. In some implementations, when there is a low condition score (e.g., 0.3 to 0.49), the system batches messages in groups of 10 to 15 and uses a 1000 ms transmission interval to optimize energy use. In some embodiments, when the device reaches a critical condition score (e.g., below 0.3), the system uses more aggressive batching (e.g., accumulating 20 or more messages and transmitting them every 2000 ms or longer).

In some embodiments, upon establishing the connection (e.g., WebSocket connection), the server and client agree to use message batching as part of the energy-efficient protocol features. In some implementations, the client transmits (e.g., communicates) its initial condition score to the server. In some embodiments, the server determines and applies an appropriate starting batch size and interval based on the received initial condition score of the device. In some implementations, the system holds messages in a buffer until either the specified batch size is reached or the interval timer expires (e.g., whichever comes first). For example, in some embodiments, when the server receives data indicating the device has a condition score of 0.4, the system determines that batches of 10 to 15 messages are to be sent every 1000 ms (e.g., and further adjusts these parameters based on message frequency and real-time conditions). In some implementations, when the condition score improves (e.g., from 0.4 to 0.6), the system reduces the batch size and interval to prioritize responsiveness. In some embodiments, the client continuously monitors its condition score and sends updates to the server as conditions change. In some implementations, when the condition score decreases, the server automatically increases the batch size and extends the transmission interval. Conversely, in some embodiments, as the condition score improves, the system adjusts batching parameters to allow smaller and more frequent transmissions. In some implementations, when message batching is unsupported or disabled, the system uses standard WebSocket behavior (e.g., transmitting messages individually and in real time).

In some embodiments, when there is a significant change in the condition score, the client notifies the server with a message containing the new score, a suggested batch size, and/or an interval, thereby allowing the server to adjust (e.g., the communication protocols) accordingly. For instance, in some implementations, the client sends a message comprising:

```
{
  “type”: “EE_Batching_Update”,
  “condition_score”: 0.35,
  “suggested_batch_size”: 15,
  “suggested_interval”: 1000
}
```

In some embodiments, upon receiving the above message, the server adapts its batching behavior based on the received parameters (e.g., a batch of messages is transmitted when the batch reaches 15 messages and/or every 1000 ms), thereby aligning the transmission rate to the current energy constraints of the client.

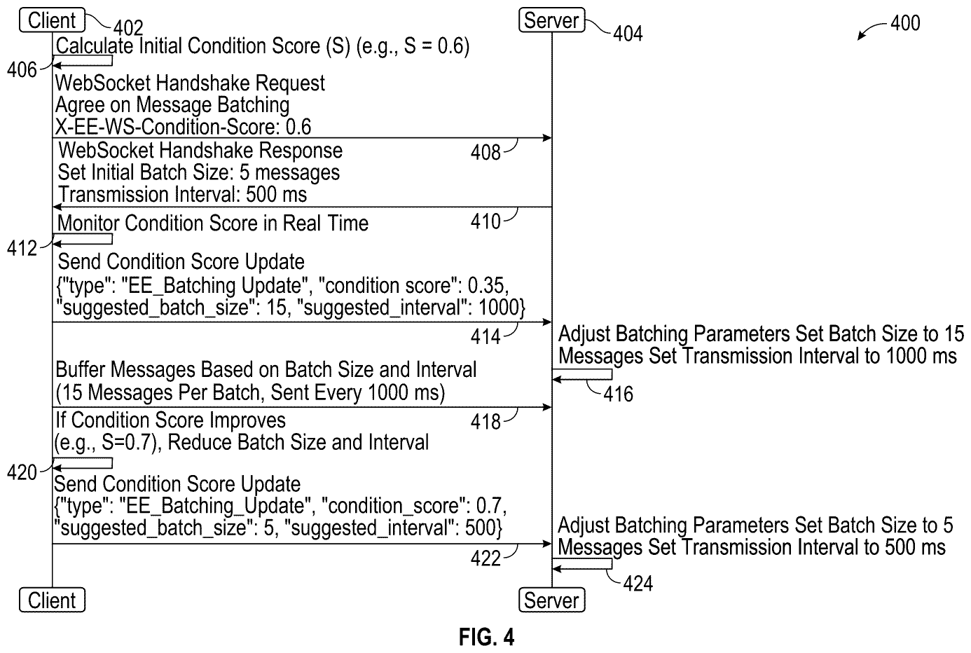

FIG. 4 is a sequence diagram that depicts process 400 comprising client 402 and server 404, in accordance with some embodiments of this disclosure. Process 400 may be implemented at least in part by, for example, system 100 of FIG. 1. In some implementations, client 402 is user device 102 of FIG. 1 and/or server 404 is application server 104 of FIG. 1. In some embodiments, at 406, client 402 calculates an initial condition score (e.g., S) to indicate resources currently available to client 402 (e.g., S=0.6 indicating that resources are moderately constrained). In some implementations, at 408, client 402 transmits, to server 404, a “WebSocket Handshake Request” indicating, for example, a request to agree on a message batching communication protocol and/or a calculated condition score (e.g., “X-EE-WS-Condition-Score: 0.6”). In some embodiments, at 410, server 404 transmits, to client 402, a “WebSocket Handshake Response” that, for example, indicates an initial batch size (e.g., “Set Initial Batch Size: 5 messages”) and/or indicates a transmission interval (e.g., “Transmission Interval: 500 ms”). In some implementations, at 412, client 302 monitors S in real time (e.g., continuously monitors measured resource parameters and updates a calculated condition score based on the changing resource parameters).

In some embodiments, at 414, client 402 sends (e.g., transmits), to server 404, a condition score update comprising the most recently calculated condition score (e.g., that reflects the current resource conditions of client 402) and, optionally, a suggested modification (e.g., update) to the communication protocol. For example, in some implementations, client 402 transmits the message “{“type”: EE_Batching_Update”, “condition_score”: 0.35, “suggested_batch_size”: 15, “suggested_interval”: 1000}.” In some embodiments, at 416, server 404 adjusts the batching parameters (e.g., sets the batch size to 15 messages and sets the transmission interval to 1000 ms). In some implementations, at 418, client 402 buffers messages based on the batch size and transmission interval set by server 404 (e.g., transmits 15 messages per batch and/or transmits batched messages every 1000 ms). In some embodiments, at 420, client 404 determines if the condition score improves (e.g., increases from 0.35 to 0.7) and, based on the improved condition score, determines that the batch size and transmission interval should be reduced. In some implementations, at 422, client 402 transmits, to server 404, a condition score update comprising the most recently calculated condition score (e.g., that reflects the current resource conditions of client 402) and, optionally, a suggested modification (e.g., update to) the communication protocol. In some implementations, client 402 transmits the message “{“type”: EE_Batching_Update”, “condition_score”: 0.7, “suggested_batch_size”: 5, “suggested_interval”: 500}.” In some embodiments, at 424, server 404 adjusts (e.g., decreases) the batching parameters, such as, for example, by setting the batch size to 5 messages and setting the transmission interval to 500 ms.

In some embodiments, the system comprises a per-message deflate extension to dynamically adjust the compression level of each message based on the condition score of a device (e.g., the client) communicating with a second device (e.g., the server). In some implementations, the device communicating with a second device calculates a condition score indicating real-time resources available to the device such as, for example, battery level, CPU load, and network stability. In some embodiments, when the condition score indicates limited resources, such as, for example, low battery, high CPU load, or unstable network, the system modifies the communication protocol (e.g., WebSocket protocol) to comprise an increased compression rate, thereby reducing the message payload size and conserving transmission energy. In some implementations, the system minimizes the amount of data sent over the network and maintains essential communication (e.g., by using the per-message deflate extension). In some embodiments, as resources become more available, the system lowers, or even turns off, the compression level in order to prioritize transmission speed and reduce processing demands on the device.

In some embodiments, the system applies context-based compression algorithms to determine the optimal compression rate for each message. In some implementations, the system uses higher compression rates for non-critical data, such as, for example, metadata or supplementary information, during low-resource states (e.g., when a condition score indicates limited resource availability). In some embodiments, the system delivers messages comprising primary content, such as, for example, user messages or critical alerts, in a way that remains legible and quick to decompress on the client side. In some implementations, the system uses a dynamic compression strategy (e.g., adapting the compression level to the resources available to the device in real time), thereby allowing for efficient data handling without compromising essential communication.

In some embodiments, the system uses dynamic message compression in real-time applications that require frequent data updates but operate on resource-constrained devices, such as, for example, wearables (e.g., FitBit, Apple Watch), IoT devices, and remote sensors. For example, in some implementations, a healthcare monitoring system (e.g., a wearable device that continuously sends heart rate and activity data to a cloud server) operating under low-battery conditions applies a higher compression to less critical status updates or contextual metrics, thereby ensuring the timely delivery of primary health metrics (e.g., measured heart rate). Similarly, in some embodiments, a smart home system comprising environmental sensors compresses non-essential data during low network connectivity or low-power states, thereby allowing crucial data to reach the server promptly.

In some embodiments, when there is a high condition score (e.g., above 0.8) indicating that the device has a high battery charge, a stable network, and a low CPU load, the application uses minimal compression to prioritize transmission speed and processing efficiency. In some implementations, the system transmits messages as uncompressed or with a low compression ratio, allowing data to be transmitted as quickly as possible without additional processing overhead. In some embodiments, when there is a moderate condition score (e.g., between 0.5 and 0.8) indicating that resources have become slightly constrained (e.g., the battery charge has dropped and/or the network signal has weakened), the application applies moderate compression to non-critical data, (e.g., periodic status updates or secondary metrics such as step counts), thereby reducing message size, conserving bandwidth and power, and allowing critical data (e.g., health data) to reach the server with minimal latency. In some implementations, when there is a low condition score (e.g., below 0.5) indicating that resources are significantly constrained (e.g., low battery, high CPU load, and/or unstable network conditions), the application applies a higher compression ratio to all messages (e.g., including heart rate and activity metrics), thereby reducing payload size as much as possible to save energy. In some embodiments, the server decompresses received data (e.g., that was transmitted having had a high compression ratio applied to it) that arrives slightly delayed (e.g., but results in conserved device resources and communication continuity until conditions improve).

In some embodiments, when the condition score of a wearable device drops below a critical threshold, the device prompts a switch to a higher compression level by transmitting the following message over the communication channel (e.g., WebSocket connection):

```
{
  “type”: “compression_update”,
  “timestamp”: “2024-10-30T12:45:00Z”,
    “new_compression_level”: “high”,
  “condition_score”: 0.45,
  “compression_algorithm”: “deflate”,
  “details”: {
      “compression_ratio”: 9,
      “target”: “non_critical data”
  }
}
Upon receiving this update, the server might respond with a simple acknowledgment: {
  “type”: “ack”,
  “status”: “compression_update_received”,
  “timestamp”: “2024-10-30T12:45:01Z”
}
```

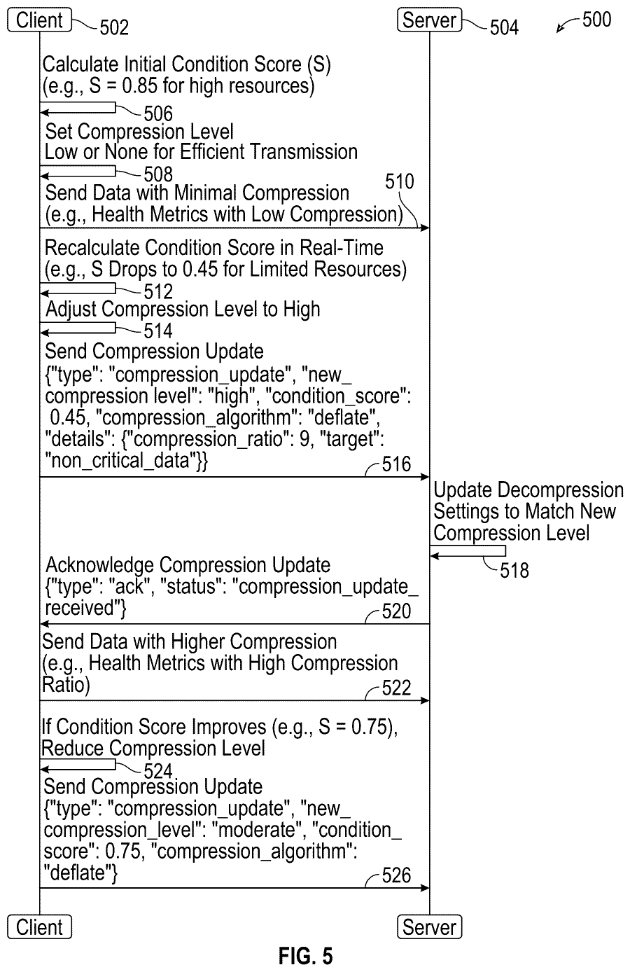

FIG. 5 is a sequence diagram that depicts process 500 comprising client 502 and server 504, in accordance with some embodiments of this disclosure. Process 500 may be implemented at least in part by, for example, system 100 of FIG. 1. In some implementations, client 502 is user device 102 of FIG. 1 and/or server 504 is application server 104 of FIG. 1. In some embodiments, client 502 and server 504 have established a WebSocket connection (e.g., by using a low-power handshake such as handshake 106 of FIG. 1). In some implementations, at 506, client 502 calculates a condition score (e.g., S=0.85) to indicate its current resource environment (e.g., high resources). In some embodiments, at 508, client 502 sets a compression level based on the calculated condition score (e.g., setting a low compression level or no compression level for efficient transmission). In some implementations, at 510, client 502 sends (e.g., transmits) data (e.g., health metrics determined by a wearable device having a sensor) to server 504 with minimal compression. In some embodiments, at 512, client 502 recalculates (e.g., continuously) a condition score to represent the real-time resource environment of client 502 (e.g., S drops to 0.45, indicating limited resources available to device 502). In some implementations, at 514, client 502 determines an adjustment to be made to the compression level (e.g., to increase the compression level to high). In some embodiments, at 516, client 502 sends (e.g., transmits) a compression update to server 504. In some implementations, client 502 transmits, to server 504, the message “{“type”: “compression_update”, “new_compression_level”: “high”, “condition_score”: 0.45, “compression_algorithm”: “deflate”, “details”: {“compression_ratio”: 9, “target”: “non_critical_data”}}.”

In some embodiments, at 518, server 504 updates the decompression settings of server 504 to match the new compression level (e.g., as set by client 502 and indicated by the message transmitted by client 502. In some implementations, at 520, server 504 transmits a message to client 502 acknowledging the compression update. For example, in some embodiments, server 504 transmits, to client 502, the message “{“type”: “ack”, “status”: “compression_update_received”}.” In some implementations, at 522, client 502 sends (e.g., transmits), to server 504, data with a higher compression (e.g., health metrics with a high compression ratio). In some embodiments, at 524, client 502 determines (e.g., by continuously monitoring resource parameters) that its condition score has improved (e.g., condition score has increased to 0.75) and that, accordingly, the compression level should be reduced. In some implementations, at 526, client 502 sends (e.g., transmits) a compression update to server 504. For example, in some embodiments, client 502 transmits, to server 504, the message “{“type”: “compression_update”, “new_compression_level”: “moderate”, “condition_score”: 0.75, “compression_algorithm”: “deflate”}.”

In some embodiments, the system applies an error-resilient transmission method that activates error-resistant encoding for messages (e.g., WebSocket messages) when the condition score of a device (e.g., client or server) indicates limited resources (e.g., low battery charge, unstable network). In some implementations, when operating in limited resource conditions, the system prioritizes reliable delivery over transmission speed by encoding messages with enhanced error resistance. In some embodiments, the system reduces data loss and minimizes the need for retransmissions by applying an error-resilient transmission method, thereby conserving energy by ensuring messages are delivered correctly on the first attempt. In some implementations, the system uses encoding techniques such as, for example, FEC or redundancy coding, thereby adding minimal extra data to each message. In some embodiments, the system uses redundancy coding to help the receiver reconstruct data even if some packets are lost, thereby ensuring critical information is retained without the need for the sender to resend the message.

For example, in some embodiments, based on the condition score of a device (e.g., client or sender), the system (e.g., the WebSocket layer) divides a message into smaller frames (e.g., Frame A, Frame B, and Frame C) and generates an additional parity frame (e.g., Frame D) by applying an XOR operation across the original frames. In some implementations, the device transmits the frames (e.g., Frames A, B, C, and D) sequentially. In some embodiments, when one frame (e.g., Frame A) is lost during transmission, the server reconstructs it using the parity frame (e.g., Frame D) and the remaining frames (e.g., Frames B and C), thereby eliminating the need to send a retransmission request to the device. In some implementations, the system effectively maintains data integrity while reducing energy usage by dividing the message into smaller frames and generating a parity frame, as the device can prioritize one-time transmissions over repeated retries under low-resource conditions.

In some embodiments, when the condition score improves (e.g., from 0.25 to 0.88), indicating stable resources, the system reverts to standard transmission methods that maximize speed and reduce processing overhead. In some implementations, the system uses an error-resilient transmission method for real-time applications such as remote health monitoring or environmental IoT sensors that require consistent data flow, even under variable network conditions. For instance, in some embodiments, a wearable device transmitting vital health metrics (e.g., heart rate or oxygen levels) to a server employs error-resilient transmission during poor connectivity or low-battery periods, ensuring these metrics reach the server accurately without a need for multiple attempts.

In some embodiments, the client transmits the following message to the server to request additional error resiliency:

```
{
  “type”: “reliability_request”,
  “timestamp”: “2024-10-30T14:00:00Z”,
  “reliability_mode”: “error_resilient”,
  “condition_score”: 0.4,
  “encoding_method”: “FEC”,
  “redundancy_level”: “medium”,
  “expected_duration”: “300” // in seconds
}
```

In some implementations, the server receives the above message and transmits the following message to the client in response:

```
{
  “type”: “ack”,
  “status”: “reliability_mode_enabled”,
  “timestamp”: “2024-10-30T14:00:01Z”,
  “encoding_method”: “FEC”,
  “redundancy_level”: “medium”,
  “duration”: “300”
}
```

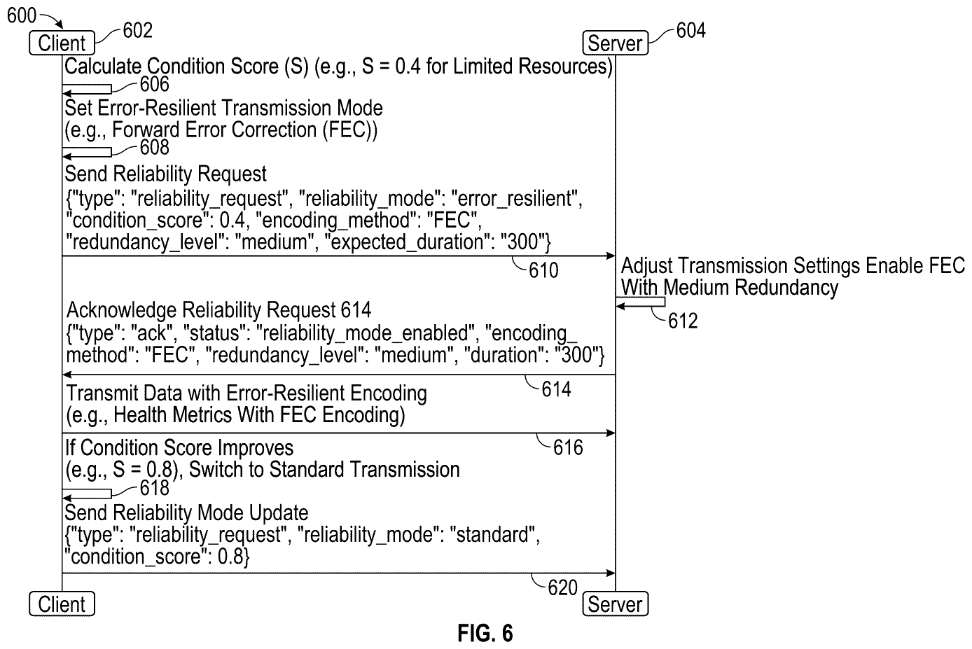

FIG. 6 is a sequence diagram that depicts process 600 comprising client 602 and server 604, in accordance with some embodiments of this disclosure. Process 600 may be implemented at least in part by, for example, system 100 of FIG. 1. In some implementations, client 602 is user device 102 of FIG. 1 and/or server 604 is application server 104 of FIG. 1. In some embodiments, client 602 and server 604 have established a WebSocket connection (e.g., by using a low-power handshake such as handshake 106 of FIG. 1). In some implementations, at 606, client 602 calculates a condition score (e.g., S=0.4) to indicate its current resource environment (e.g., limited resources). In some embodiments, at 608, client 602 sets (e.g., activates) an error-resilient transmission mode, such as, for example, FEC. In some implementations, at 610, client 602 sends (e.g., transmits) a reliability request to server 604. For example, in some embodiments, client 602 transmits, to server 604, the message “{“type”: “reliability_request”, “reliability_mode”: “error_resilient”, “condition_score”: 0.4, “encoding_method”: “FEC”, “redundancy_level”: “medium”, “expected_duration”: “300”}.”

In some embodiments, at 612, server 604 adjusts the transmission settings for the communication protocol between client 602 and server 604 (e.g., enables FEC with medium redundancy). In some implementations, at 614, server 604 acknowledges the reliability request such as, for example, by transmitting, to client 602, the message “{“type”: “ack”, “status”: “reliability_mode_enabled”, “encoding_method”: “FEC”, “redundancy_level”: “medium”, “duration”: “300”}.” In some embodiments, at 616, client 602 transmits data (e.g., to server 604) with error-resilient encoding, such as, for example, health metrics with FEC encoding. In some implementations, at 618, client 602 determines (e.g., by continuously monitoring resource parameters) if the condition score has improved and, upon determining that the condition score has improved (e.g., S has increased from 0.4 to 0.8), client 602 switches to standard transmission (e.g., deactivates error-resilient transmission mode). In some embodiments, at 620, client 602 sends (e.g., transmits to server 604) a reliability mode update. For example, in some implementations, client 602 transmits (e.g., to server 604) the message “{“type”: “reliability_request”, “reliability_mode”: “standard”, “condition_score”: 0.8}.”

In some embodiments, the system uses adaptive frame segmentation to dynamically adjust the size of message frames based on the condition score (e.g., of the client and/or the server) which indicates resource factors such as, for example, battery level, network stability, and CPU load. In some implementations, the system recalculates the condition score periodically to account for changes in resources. In some embodiments, when the condition score indicates limited resources (e.g., low battery, high CPU load, constrained network bandwidth), the system uses application-layer control to signal the communication protocol (e.g., WebSocket protocol) to divide larger messages into smaller frame segments. In some implementations, the system uses message segmentation to reduce the immediate processing and transmission demands of the device, thereby allowing for incremental data transmission that conserves energy and prevents resource overuse. In some embodiments, the system sends each frame sequentially over the connection (e.g., WebSocket connection), thereby ensuring a steady data flow without overburdening the device. Conversely, in some implementations, when resources improve and the condition score increases accordingly, the application signals the communication protocol (e.g., WebSocket protocol) to increase frame size, thereby allowing larger segments to be transmitted at once. In some embodiments, the system applies adjustments to frame size transmission (e.g., increasing the frame size when resources improve) to allow faster data transfer and minimize latency (e.g., improves transmission speed when device conditions permit).

For example, in some embodiments, a wearable device on an athlete supporting an outdoor sports tracking application streams performance metrics (e.g., speed, altitude, heart rate) to a coaching application in real time. In some implementations, when the battery level of the wearable device drops or network conditions become unstable, the system conserves energy by breaking the performance data packets into smaller frames, thereby allowing the wearable device to send updates incrementally. In some embodiments, the coaching app reassembles the smaller frames continuously, thereby maintaining a steady flow of data even under limited resources. In some implementations, as the battery of the wearable device recharges or connectivity improves, the wearable device sends larger frames, thereby increasing data transfer speeds and allowing for more immediate feedback.

In some embodiments, each time the condition score changes significantly, the device sends a frame segmentation update message to notify the server of the new segmentation settings, such as, for example, the following:

```
{
  “type”: “frame_segmentation_update”,
  “timestamp”: “2024-10-30T16:00:00Z”,
  “segmentation_mode”: “adaptive”,
  “condition_score”: 0.3,
  “frame_size”: “small”,
  “segment_count”: 15,
  “reason”: “Low battery and reduced network stability”
}
```

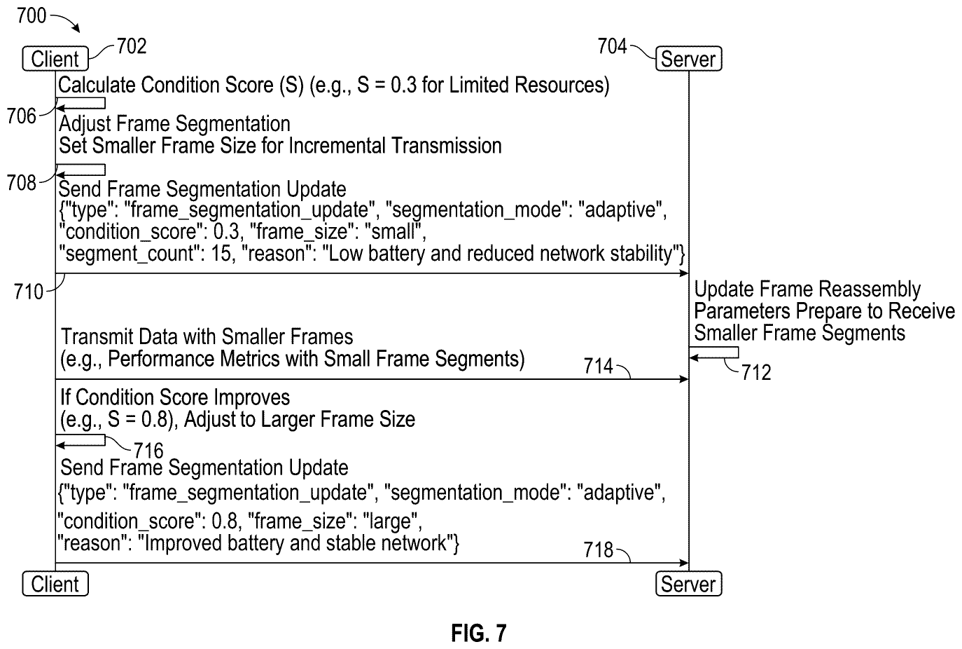

FIG. 7 is a sequence diagram that depicts process 700 comprising client 702 and server 704, in accordance with some embodiments of this disclosure. Process 700 may be implemented at least in part by, for example, system 100 of FIG. 1. In some implementations, client 702 is user device 102 of FIG. 1 and/or server 704 is application server 104 of FIG. 1. In some embodiments, client 702 and server 704 have established a WebSocket connection (e.g., by using a low-power handshake such as, for example, handshake 106 of FIG. 1). In some implementations, at 706, client 702 calculates a condition score (e.g., S=0.3) that indicates its current resource environment (e.g., limited resources). In some embodiments, at 708, client 702 adjusts the frame segmentation setting based on the calculated condition score (e.g., sets smaller frame size for incremental transmission). In some implementations, at 710, client 702 sends (e.g., transmits to server 704) a frame segmentation update, such as, for example, the message “{“type”: “frame_segmentation_update”, “segmentation_mode”: “adaptive”, “condition_score”: 0.3, “frame_size”: “small”, “segment_count”: 15, “reason”: “Low battery and reduced network stability”}.”

In some embodiments, at 712, server 704 updates the frame reassembly parameters of server 704 (e.g., based on the received frame segmentation update) to prepare to receive smaller frame segments. In some implementations, at 714, client 702 transmits, to server 704, data with smaller frames (e.g., performance metrics with small frame segments). In some embodiments, at 716, client 702 determines (e.g., by continuously monitoring resource parameters) that a condition score representing its resource environment has improved (e.g., from 0.3 to 0.8) and, accordingly, adjusts to a larger frame size transmission setting. In some implementations, at 718, client 702 sends (e.g., transmits to server 704) a frame segmentation update, such as, for example, the message “{“type”: “frame_segmentation_update”, “segmentation_mode”: “adaptive”, “condition_score”: 0.8, “frame_size”: “large”, “reason”: “Improved battery and stable network”}.”

In some embodiments, the system configures the communication protocol (e.g., WebSocket protocol) to allow a primary device with low resources (e.g., low battery) to offload its data retrieval to a nearby secondary device (e.g., a tablet or smartphone) having higher resources (e.g., fully charged battery). In some implementations, when the condition score of the primary device indicates resource limitations, the device sends a support request to the server (e.g., WebSocket server) to signal that it is in low-power mode and requires assistance (e.g., from a nearby secondary device). In some embodiments, the server (e.g., the WebSocket server) responds to the support request from the device by creating a unique synchronization identifier for the session and sending this identifier and connection parameters to the primary device. In some implementations, the primary device transmits the identifier and relevant connection details to an identified secondary device over a low-energy connection, such as, for example, Bluetooth Low Energy (BLE).

In some embodiments, the system creates the synchronization identifier to allow the secondary device to securely connect to the server (e.g., WebSocket server) on behalf of the primary device, thereby establishing a session that maintains data continuity. In some implementations, the secondary device, upon receiving the synchronization identifier, initiates a connection (e.g., WebSocket connection) to the server, the connection optionally being a high-energy connection (e.g., cellular), and begins fetching data. In some embodiments, the primary device switches from the high-energy connection (e.g., to the server) to a BLE connection (e.g., to the secondary device), and subsequently receives data from the secondary device (e.g., as originally transmitted by the server). In some implementations, the system allows the primary device to conserve energy while maintaining essential data flows (e.g., real-time health metrics or location tracking) by offloading data retrieval to a nearby secondary device. In some embodiments, when the condition score of the primary device improves (e.g., when it is recharged), the server (e.g., WebSocket server) prompts the primary device to resume direct communication and subsequently ends the proxying by the secondary device. In some implementations, the system uses this handoff mechanism (e.g., sending data to a secondary device intended for a primary device) to allow efficient data transmission under constrained resources, making it ideal for applications where a primary device, such as, for example, a wearable or IoT device, requires continuous data connectivity but may experience periods of low resources.

In some embodiments, when the condition score of a first device (e.g., primary device) drops, the first device sends a support request to the server, indicating that it requires assistance and providing the secondary device's identifier, such as, for example, the following request:

```
{
  “type”: “low_battery_support_request”,
  “device_id”: “primary_device_001”,
  “condition_score”: 0.2,
  “support_device_id”: “secondary_device_002”,
    “request_timestamp”: “2024-10-30T14:00:00Z”
}
```

In some implementations, the server (e.g., in response to receiving the support request) creates a synchronization identifier and transmits a message to the first device comprising data relevant to enabling a secondary device to begin assisting, such as, for example, the following message:

```
{
  “type”: “support_response”,
  “synchronization_id”: “sync12345”,
  “primary_device_id”: “primary_device_001”,
  “support_device_id”: “secondary_device_002”,
  “protocol”: “BLE”,
  “target_server”: “ws://server.example.com”,
  “support_start_timestamp”: “2024-10-30T14:00:01Z”
}
```

In some embodiments, the first device (e.g., in response to receiving the message from the server) transmits the synchronization identifier and connection parameters to a secondary device over BLE, instructing it to take over WebSocket data retrieval, such as, for example, the following message:

```
{
  “type”: “support_initiate”,
  “synchronization_id”: “sync12345”,
  “primary_device_id”: “primary_device_001”,
  “connection_parameters”: {
    “protocol”: “BLE”,
    “target_server”: “ws://server.example.com” },
  “reason”: “Low battery and limited resources”
}
```

In some implementations, in response to receiving the above message, the secondary device initiates a connection (e.g., WebSocket connection) with the server using the synchronization identifier, effectively taking over data retrieval on behalf of the primary device, such as, for example, by transmitting the following message:

```
{
  “type”: “proxy_connection”,
  “synchronization_id”: “sync12345”,
  “support_device_id”: “secondary_device_002”,
  “target_device”: “primary_device_001”,
  “connection_start_timestamp”: “2024-10-30T14:00:05Z”
}
```

In some embodiments, the server confirms the establishment of the proxy connection with the secondary device, allowing it to proceed with data retrieval, such as, for example, by transmitting the following message:

```
{
  “type”: “ack”,
  “status”: “proxy_connection_established”,
  “synchronization_id”: “sync12345”,
  “support_device_id”: “secondary_device_002”,
    “timestamp”: “2024-10-30T14:00:06Z”
}
```

In some implementations, the server notifies the primary device that the handoff is complete, confirming that it can switch to receiving data over BLE from the secondary device, such as, for example, by transmitting the following message:

```
{
  “type”: “handoff_complete”,
  “synchronization_id”: “sync12345”,
  “support_device_id”: “secondary_device_002”,
  “timestamp”: “2024-10-30T14:00:06Z”,
    “status”: “data_relay_active”
}
```

In some embodiments, the secondary device receives data (e.g., WebSocket data) from the server and relays it to the primary device over BLE in small packets, such as, for example, by transmitting the following data packet to the primary device:

```
{
  “type”: “data_relay”,
  “synchronization_id”: “sync12345”,
  “data”: {
    “metric”: “athletic_performance_metric”,
      “value”: 72,
    “timestamp”: “2024-10-30T14:01:00Z”
  }
}
```

In some implementations, when the condition score of the primary device improves (e.g., increases), the primary device sends a message to the server requesting to resume direct communication and consequently terminate the proxy connection, such as, for example, by transmitting the following message:

```
{
  “type”: “resume_direct_connection”,
  “device_id”: “primary_device_001”,
  “condition_score”: 0.8,
  “synchronization_id”: “sync12345”,
  “timestamp”: “2024-10-30T14:05:00Z”
}
```

In some embodiments, the server notifies the secondary device that it can terminate the proxy connection and stop data relay, such as, for example, by transmitting the following message:

```
{
  “type”: “terminate_proxy”,
  “synchronization_id”: “sync12345”,
  “status”: “direct_connection_resumed”,
  “timestamp”: “2024-10-30T14:05:01Z”
}
```

FIG. 8 is a sequence diagram that depicts process 800 comprising client 802, server 804, and secondary device 806, in accordance with some embodiments of this disclosure. Process 800 may be implemented at least in part by, for example, system 100 of FIG. 1. In some implementations, client 802 is user device 102 of FIG. 1 and/or server 804 is application server 104 of FIG. 1. In some embodiments, client 802 and server 804 have established a WebSocket connection (e.g., by using a low-power handshake such as handshake 106 of FIG. 1). In some implementations, at 808, client 802 transmits a support request to server 804. For example, in some embodiments, client 802 transmits, to server 804, the message “{“type”: “low_battery_support_request”, “device_id”: “primary_device_001”, “condition_score”: 0.2, “support_device_id”: “secondary_device_002”}.” In some implementations, at 810, server 804 transmits a synchronization ID response to client 802. For example, in some embodiments, server 804 transmits the message “{“type”: “support_response”, “synchronization_id”: “sync12345”, “primary_device_id”: “primary_device_001”, “support_device_id”: “secondary_device_002”, “protocol”: “BLE”}.” In some implementations, at 812, client 802 transmits a handoff message to secondary device 806. For example, in some embodiments, client 802 transmits, to secondary device 806, the message “{“type”: “support_initiate”, “synchronization_id”: “sync12345”, “primary_device_id”: “primary_device_001”, “connection_parameters”: {“protocol”: “BLE”}}.”

In some embodiments, at 814, secondary device 806 transmits a proxy connection request to server 804, such as, for example, the message “{“type”: “proxy_connection”, “synchronization_id”: “sync12345”, “support_device_id”: “secondary_device_002”, “target_device”: “primary_device_001”}.” In some implementations, at 816, server 804 transmits a proxy connection acknowledgement to secondary device 806, such as the message “{“type”: “ack”, “status”: “proxy_connection_established”, “synchronization_id”: “sync12345”}.” In some embodiments, at 818, server 804 transmits, to client 802, a message indicating that the handoff (e.g., from client 802 to secondary device 806) is complete, such as, for example, the message “{“type”: “handoff_complete”, “synchronization_id”: “sync12345”, “status”: “data_relay_active”}.” In some implementations, at 820, secondary device 806 performs a data relay (e.g., from server 804 to client 802) over BLE. For example, in some embodiments, secondary device 806 transmits, to client 802, the message “{“type”: “data_relay”, “synchronization_id”: “sync12345”, “data”: {“metric”: “heart_rate”, “value”: 72}}.” In some implementations, at 822, client 802 transmits a “Resume Direct Connection Request” to server 804 (e.g., based on determining that resources can support a direct connection). For example, in some embodiments, client 802 transmits, to server 804, the message “{“type”: “resume_direct_connection”, “device_id”: “primary_device_001”, “condition_score”: 0.8, “synchronization_id”: “sync12345”}.” In some implementations, at 824, server 804 transmits a “Terminate Proxy Connection” message to secondary device 806 (e.g., in response to receiving the “Resume Direct Connection Request” from client 802). For example, in some embodiments, server 804 transmits, to secondary device 806, the message “{“type”: “terminate_proxy”, “synchronization_id”: “sync12345”, “status”: “direct_connection_resumed”}.”

In some embodiments, the system causes the communication protocol (e.g., WebSocket protocol) to dynamically adjust data updates based on user presence, e.g., as detected through IoT sensors or device proximity. In some implementations, the system causes dynamic adjustments to the communication protocol when the connection is persistent to allow the server to optimize data delivery by prioritizing content when the user is actively present and deprioritizing it when the user is absent. In some embodiments, the system uses presence detection from signals (e.g., Bluetooth or Wi-Fi) and/or data from IoT sensors to determine user presence. In some implementations, the primary client provides the server (e.g., WebSocket server) with an indication of user engagement status. In some embodiments, when presence is detected, the server maintains a high frequency of real-time updates, thereby ensuring timely information delivery.

In some embodiments, when the system determines that the user is not proximal to the device, the server reduces or temporarily pauses non-essential updates and extends the interval between messages to conserve bandwidth and device resources. In some implementations, the system uses techniques like frame batching (e.g., where multiple updates are bundled into a single transmission to reduce transmission frequency) and adaptive keep-alive (e.g., adjusting the interval of keep-alive signals to maintain the connection at minimal energy cost) to allow for adaptive behavior (e.g., in response to detected user engagement/proximity to the device). Additionally, in some embodiments, the system applies dynamic message compression to reduce data size for lower-priority updates, thereby ensuring that essential content is delivered with minimal impact on bandwidth. In some implementations, when the system determines that a user is present (e.g., after previously not being present), the server resumes normal update intervals and/or transmits an immediate snapshot of the latest data, thereby ensuring the user receives up-to-date information upon re-engagement.

In some embodiments, when a client device detects user presence, the client device sends a message to the server (e.g., WebSocket server) to indicate that the user is actively engaged (e.g., to signal the server to prioritize real-time updates), such as, for example, by transmitting the following message:

```
{
  “type”: “presence_update”,
  “device_id”: “smart_tv_001”,
  “user_presence”: “present”,
  “timestamp”: “2024-10-30T10:15:00Z”
}
```

In some embodiments, when the client device is a smart TV, the client device detects the user presence through a camera integrated within the smart TV or otherwise connected to the smart TV. For example, in some implementations, a smart TV detects a user presence via a connected camera and performs an action corresponding to the determined presence (e.g., modifies transmission frequency, modifies update frequency). In some implementations, the server responds by adjusting the update frequency for high-priority, real-time delivery. In some embodiments, the server transmits a response including parameters for intelligent frame batching and dynamic message compression to optimize the data stream, such as, for example, the following message:

```
{
  “type”: “update_frequency_change”,
  “device_id”: “smart_tv_001”,
  “status”: “high_frequency”,
  “update_interval”: 5, // seconds
  “batch_size”: 3, // messages per batch
  “compression_level”: “low”, // minimal compression to prioritize speed
  “keep_alive_interval”: 30, // seconds
  “timestamp”: “2024-10-30T10:15:01Z”
}
```

In some embodiments, when the system determines that the user is not proximate to the device (e.g., has left the area), the client device sends a presence update notifying the server of the absence (e.g., to signal the server to reduce the update frequency or apply more aggressive batching and compression), such as, for example, the following message:

```
{
  “type”: “presence_update”,
  “device_id”: “smart_tv_001”,
  “user_presence”: “absent”,
  “timestamp”: “2024-10-30T10:20:00Z”
}
```

In some implementations, in response to receiving the indication of the absence (e.g., of the user), the server reduces the update frequency and further optimizes for resource conservation. In some embodiments, the server transmits a response that indicates extended intervals, larger batch sizes, and a higher compression level, such as, for example, the following message:

```
{
  ″type″: ″update_frequency_change″,
  ″device_id″: ″smart_tv_001″,
  ″status″: ″low_frequency″,
  ″update_interval″: 60, // seconds
  ″batch_size″: 10, // messages per batch
  ″compression_level″: ″high″, // maximum compression to conserve bandwidth
  “keep_alive_interval″: 120, // seconds
  ″timestamp″: ″2024-10-30T10:20:01Z″
}
```

In some embodiments, upon detecting the return of the user (e.g., to the device), the server sends a snapshot of the latest data to synchronize the user with current information, thereby providing an immediate, comprehensive update. In some implementations, the server transmits the following message:

```
{
  “type”: “snapshot_update”,
    “device_id”: “smart_tv_001”,
    “data”: {
      “latest_score”: “3-2”,
      “quarter”: “4th”,
      “time_remaining”: “02:30”
  },
  “timestamp”: “2024-10-30T10:25:00Z”
}
```

FIG. 9 is a sequence diagram that depicts process 900 comprising client 902 and server 904, in accordance with some embodiments of this disclosure. Process 900 may be implemented at least in part by, for example, system 100 of FIG. 1. In some implementations, client 902 is user device 102 of FIG. 1 and/or server 904 is application server 104 of FIG. 1. In some embodiments, client 902 and server 904 have established a WebSocket connection (e.g., by using a low-power handshake such as handshake 106 of FIG. 1). In some embodiments, server 904 is a server of a live sports streaming application and client 902 is a smart TV. In some implementations, at 906, client 902 transmits a presence update to server 904, such as the message “{“type”: “presence_update”, “device_id”: “smart_tv_001”, “user_presence”: “present”, “timestamp”: “2024-10-30T10:15:00Z”}.” In some embodiments, at 908, server 904 adjusts to high-frequency updates (e.g., in response to receiving an indication that the user is present), such as, for example, by transmitting, to client 902, the message “{“type”: “update_frequency_change”, “device_id”: “smart_tv_001”, “status”: “high_frequency”, “update_interval”: 5, “batch_size”: 3, “compression_level”: “low”, “keep_alive_interval”: 30}.” In some implementations, at 910, client 902 transmits a presence update to server 904 (e.g., based on determining that the user is absent). For example, in some embodiments, client 902 transmits, to server 904, the message “{“type”: “presence_update”, “device_id”: “smart_tv_001”, “user_presence”: “absent”, “timestamp”: “2024-10-30T10:20:00Z”}.”

In some embodiments, at 912, server 904 adjusts to low-frequency updates (e.g., based on receiving the presence update from client 902), such as, for example, by transmitting, to client 902, the message “{“type”: “update_frequency_change”, “device_id”: “smart_tv_001”, “status”: “low_frequency”, “update_interval”: 60, “batch_size”: 10, “compression_level”: “high”, “keep_alive_interval”: 120}.” In some implementations, at 914, client 902 transmits a presence update to server 904 (e.g., based on determining that the user has returned). For example, in some embodiments, client 902 transmits, to server 904, the message “{“type”: “presence_update”, “device_id”: “smart_tv_001”, “user_presence”: “present”, “timestamp”: “2024-10-30T10:25:00Z”}.” In some implementations, at 916, server 904 sends (e.g., transmits to client 902) a snapshot update (e.g., in response to receiving the presence update from client 902), such as, for example, the message “{“type”: “snapshot_update”, “device_id”: “smart_tv_001”, “data”: {“latest_score”: “3-2”, “quarter”: “4th”, “time_remaining”: “02:30”}}.” In some embodiments, at 918, server 904 resumes high-frequency updates, such as, for example, by transmitting, to client 902, the message “{“type”: “update_frequency_change”, “device_id”: “smart_tv_001”, “status”: “high_frequency”, “update_interval”: 5, “batch_size”: 3, “compression_level”: “low”, “keep_alive_interval”: 30}.”

In some embodiments, the system dynamically adjusts message delivery based on user interaction and device state, using frame batching, dynamic message compression, adaptive keep-alive, and pausing techniques to ensure relevant updates reach the user while conserving resources. For example, in some implementations, the system dynamically adjusts message delivery for applications executing on wearables (e.g., FitBit watch, Apple Watch), where data relevancy is closely tied to user engagement and device activity. In some embodiments, when a user actively engages with an application, such as, for example, a stock widget, the server increases the priority of real-time updates by delivering the latest and most relevant data with minimal compression and low-latency configurations. In some implementations, when the system determines that the user has not interacted with the device within a threshold period of time and/or that the device has been stationary for a threshold period of time, the server deprioritizes non-critical updates, minimizes data flow by reducing the update frequency, applies dynamic message compression to lower data payload sizes, and/or extends the adaptive keep-alive interval to conserve energy. In some embodiments, the server retains only the latest data snapshot, which is pushed to the user upon receiving an indication that the user has re-engaged with the device. In some implementations, the system prevents unnecessary data transmission, reduces bandwidth consumption, and conserves battery power during inactivity, while ensuring the user sees the most current information upon re-engagement, by using any suitable combination of pausing, compression, and batching techniques.

For example, in some embodiments, when the system detects that a user has lifted their wrist to view metrics provided by a stock tracking app or widget executed on a smart watch, the client sends an engagement update to the WebSocket server, prompting it to prioritize real-time updates. In some implementations, when the system determines that a user has not checked the application (e.g., the stock tracking app) recently, the system deprioritizes incremental stock updates and causes only a periodic snapshot to be sent. In some embodiments, when the system determines that the user has re-engaged (e.g., with the stock tracking app), the server (e.g., WebSocket server) transmits an immediate snapshot to provide the latest stock prices, thereby conserving resources while keeping the user informed with current information.

FIG. 10 is a sequence diagram that depicts process 1000 comprising client 1002 and server 1004, in accordance with some embodiments of this disclosure. Process 1000 may be implemented at least in part by, for example, system 100 of FIG. 1. In some implementations, client 1002 is user device 102 of FIG. 1 and/or server 1004 is application server 104 of FIG. 1. In some embodiments, client 1002 and server 1004 have established a WebSocket connection (e.g., by using a low-power handshake such as handshake 106 of FIG. 1). In some embodiments, server 1004 is a server of a stock tracking application and client 1002 is a wearable device (e.g., Apple watch). In some implementations, at 1006, client 1002 transmits a user engagement update to server 1004. For example, in some embodiments, client 1002 transmits, to server 1004, the message “{“type”: “interaction_update”, “device_id”: “wearable_001”, “interaction_state”: “active”, “timestamp”: “2024-10-30T12:00:00Z”}.” In some implementations, at 1008, server 1004 prioritizes real-time updates, such as, for example, by transmitting, to client 1002, the message “{“type”: “priority_update”, “device_id”: “wearable_001”, “status”: “high_priority”, “update_interval”: 5, “batch_size”: 3, “compression_level”: “low”, “keep_alive_interval”: 30}.” In some embodiments, at 1010, client 1002 transmits a user inactivity update to server 1004 (e.g., based on determining that the user has not engaged with client 1002 for a threshold period of time). For example, in some implementations, client 1002 transmits, to server 1004, the message “{“type”: “ineraction_update”: “device_id”: “wearable_001”, “interaction_state”: “inactive”, “timestamp”: “2024-10-30T12:05:00Z”}.”

In some embodiments, at 1012, server 1004 switches to low-frequency updates (e.g., based on receiving the user inactivity update from 1002) such as by transmitting, to client 1002, the message “{“type”: “priority_update”, “device_id”: “wearable_001”, “status”: “low_priority”, “update_interval”: 60, “batch_size”: 10, “compression_level”: “high”, “keep_alive_interval”: 120}.” In some implementations, at 1014, client 1002 transmits, to server 1004, a user re-engagement update, such as, for example, the message “{“type”: “interaction_update”, “device id”: “wearable_001”, “interaction_state”: “active”, “timestamp”: “2024-10-30T12:10:00Z”}.” In some embodiments, at 1016, server 1004 sends (e.g., transmits to client 1002) an immediate snapshot, such as the message “{“type”: “snapshot_update”, “device_id”: “wearable_001”, “data”: {“stock_symbol”: “TSLA”, “current_price”: 312.45, “change”: “+3.15”}, “timestamp”: “2024-10-30T12:10:01Z”}.” In some implementations, at 1018, server 1004 resumes high-priority updates, such as, for example, by transmitting, to client 1002, the message “{“type”: “priority_update”, “device_id”: “wearable_001”, “status”: “high_priority”, “update_interval”: 5, “batch_size”: 3, “compression_level”: “low”, “keep_alive_interval”: 30}.”

FIG. 11 shows generalized embodiments of illustrative user equipment devices 1100 and 1101. For example, user equipment device 1100 may be a smartphone device (e.g., user device 102 of FIG. 1). In another example, user equipment device 1101 may be a user television equipment system. User television equipment system 1101 may include set-top box 1116. Set-top box 1116 may be communicatively connected to microphone 1118, speaker 1114, and display 1112. In some embodiments, microphone 1118 may receive voice commands for a media or communication application. In some embodiments, display 1112 may be a television display or a computer display. In some embodiments, set-top box 1116 may be communicatively connected to user input interface 1110. In some embodiments, user input interface 1110 may be a remote control device or a touchscreen. Set-top box 1116 may include one or more circuit boards. In some embodiments, the circuit boards may include processing circuitry, control circuitry, and storage (e.g., RAM, ROM, hard disk, removable disk, etc.). In some embodiments, the circuit boards may include an input/output path. More specific implementations of user equipment devices are discussed below in connection with FIG. 12. Each one of user equipment device 1100 and user equipment device 1101 may receive content and data via input/output (I/O) path 1102. In some embodiments, I/O path 1102 is I/O circuitry. I/O path 1102 may provide content (e.g., control data, messages, calls, broadcast programming, on-demand programming, Internet content, content available over a local area network (LAN) or wide area network (WAN), and/or other content) and data to control circuitry 1104, which includes processing circuitry 1106 and storage 1108. Storage 1108 comprises the instructions for managing adjustable communication protocols as described in FIGS. 1-10, when executed by processing circuitry 1106. Control circuitry 1104 may be used to send and receive commands, requests, and other suitable data using I/O path 1102, which may comprise I/O circuitry. I/O path 1102 may connect control circuitry 1104 (and specifically processing circuitry 1106) to one or more communications paths (described below). I/O functions may be provided by one or more of these communications paths, but are shown as a single path in FIG. 11 to avoid overcomplicating the drawing.

Control circuitry 1104 may be based on any suitable processing circuitry such as, for example, processing circuitry 1106. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1104 executes instructions stored in memory (e.g., storage 1108) for managing adjustable communication protocols as described in FIGS. 1-10. Specifically, control circuitry 1104 may perform the functions discussed above and below. In some implementations, any action performed by control circuitry 1104 may be based on instructions received from the adaptive communication protocols system (e.g., system 100 of FIG. 1).

In client/server-based embodiments, control circuitry 1104 may include communications circuitry suitable for communicating with a communications application server or other networks or servers. The instructions for carrying out the above-mentioned functionality may be stored on a server (which is described in more detail in connection with FIG. 12). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 12). In addition, communications circuitry may include circuitry that enables peer-to-peer communication of user equipment devices, communication between a user and a contact of the user, or communication of user equipment devices in locations remote from each other (described in more detail below).

Memory may be an electronic storage device provided as storage 1108 that is part of control circuitry 1104. As referred to herein, the phrase “electronic storage device” or “storage device” should be understood to mean any device for storing electronic data, computer software, or firmware, such as, for example, random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 1108 may be used to store various types of content described herein as well as user preferences. Nonvolatile memory may also be used (e.g., to launch a boot-up routine and other instructions). Cloud-based storage, described in relation to FIG. 12, may be used to supplement storage 1108 or instead of storage 1108.

Control circuitry 1104 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 1104 may also include scaler circuitry for upconverting and downconverting content into the preferred output format of user equipment 1100. Circuitry 1104 may also include digital-to-analog converter circuitry and analog-to-digital converter circuitry for converting between digital and analog signals. The tuning and encoding circuitry may be used by user equipment device 1100, 1101 to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 1108 is provided as a separate device from user equipment device 1100, the tuning and encoding circuitry (including multiple tuners) may be associated with storage 1108.

A user may send instructions to control circuitry 1104 using user input interface 1110. User input interface 1110 may be any suitable user interface, such as a remote control, mouse, trackball, keypad, keyboard, touch screen, touchpad, stylus input, joystick, voice recognition interface, or other user input interfaces. Display 1112 may be provided as a stand-alone device or integrated with other elements of each one of user equipment device 1100 and user equipment device 1101. For example, display 1112 may be a touchscreen or touch-sensitive display. In such circumstances, user input interface 1110 may be integrated with or combined with display 1112. Display 1112 may be one or more of a monitor, a television, a display for a mobile device, or any other type of display. A video card or graphics card may generate the output to display 1112. The video card may be any processing circuitry described above in relation to control circuitry 1104. The video card may be integrated with the control circuitry 1104. Speakers 1114 may be provided as integrated with other elements of each one of user equipment device 1100 and user equipment device 1101 or may be stand-alone units. The audio component of videos and other content displayed on display 1112 may be played through the speakers 1114. In some embodiments, the audio may be distributed to a receiver (not shown), which processes and outputs the audio via speakers 1114.

The system for managing adjustable communication protocols as described in FIGS. 1-10 may be implemented using any suitable architecture. For example, it may be a stand-alone system wholly-implemented on each one of user equipment device 1100 and user equipment device 1101. In such an approach, instructions of the system are stored locally (e.g., in storage 1108), and data for use by the system is downloaded on a periodic basis (e.g., from an out-of-band feed, from an Internet resource, or using another suitable approach). Control circuitry 1104 may retrieve instructions for the system from storage 1108 and process the instructions to perform the managing adjustable communication protocols. Based on the processed instructions, control circuitry 1104 may determine what action to perform when input is received from user input interface 1110. For example, movement of a cursor on a display up/down may be indicated by the processed instructions when user input interface 1110 indicates that an up/down button was selected.

In some embodiments, the system for managing adjustable communication protocols is a client/server-based application. Data for use by a thick or thin client implemented on each one of user equipment device 1100 and user equipment device 1101 is retrieved on-demand by issuing requests to a server remote to each one of user equipment device 1100 and user equipment device 1101. In one example of a client/server-based guidance application, control circuitry 1104 runs a web browser that interprets web pages provided by a remote server. For example, the remote server may store the instructions for the communication protocol management system in a storage device. The remote server may process the stored instructions using circuitry (e.g., control circuitry 1104) to perform the operations discussed in connection with FIGS. 1-10 and 13.

In some embodiments, the system for managing adjustable communication protocols may be downloaded and interpreted or otherwise run by an interpreter or virtual machine (run by control circuitry 1104). In some embodiments, the system for managing adjustable communication protocols may be encoded in the ETV Binary Interchange Format (EBIF), received by the control circuitry 1104 as part of a suitable feed, and interpreted by a user agent running on control circuitry 1104. For example, the system for protecting and managing usage of user data for AI model training may be an EBIF application. In some embodiments, the system for managing adjustable communication protocols may be defined by a series of JAVA-based files that are received and run by a local virtual machine or other suitable middleware executed by control circuitry 1104. In some of such embodiments (e.g., those employing MPEG-2 or other digital media encoding schemes), the system for managing adjustable communication protocols may be, for example, encoded and transmitted in an MPEG-2 object carousel with the MPEG audio and video packets of a program.

FIG. 12 shows illustrative devices and systems for managing adjustable communication protocols, in accordance with some embodiments of this disclosure. User equipment devices 1207, 1208, 1210 (e.g., user device 101) may be coupled to communication network 1206. Communication network 1206 may be one or more networks including the Internet, a mobile phone network, mobile voice or data network (e.g., a 4G or LTE network), cable network, public switched telephone network, or other types of communication network or combinations of communication networks. Paths (e.g., depicted as arrows connecting the respective devices to the communication network 1206) may separately or together include one or more communications paths, such as, for example, a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 12 to avoid overcomplicating the drawing.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network 1206.

System 1200 includes a media content source 1202 and a server 1204, which may comprise or be associated with database 1205. Communications with media content source 1202 and server 1204 may be exchanged over one or more communications paths but are shown as a single path in FIG. 12 to avoid overcomplicating the drawing. In addition, there may be more than one of each of media content source 1202 and server 1204, but only one of each is shown in FIG. 12 to avoid overcomplicating the drawing. If desired, media content source 1202 and server 1204 may be integrated as one source device.

In some embodiments, server 1204 may include control circuitry 1211 and a storage 1214 (e.g., RAM, ROM, Hard Disk, Removable Disk, etc.). Server 1204 may also include an input/output path 1212. I/O path 1212 may provide device information, or other data, over a local area network (LAN) or wide area network (WAN), and/or other content and data to the control circuitry 1211, which includes processing circuitry, and storage 1214. The control circuitry 1211 may be used to send and receive commands, requests, and other suitable data using I/O path 1212, which may comprise I/O circuitry. I/O path 1212 may connect control circuitry 1204 (and specifically processing circuitry) to one or more communications paths.

Control circuitry 1211 may be based on any suitable processing circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 1211 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, the control circuitry 1211 executes instructions for an emulation system application stored in memory (e.g., the storage 1214). Memory may be an electronic storage device provided as storage 1214 that is part of control circuitry 1211.

Server 1204 may retrieve guidance data from media content source 1202, process the data as will be described in detail below, and forward the data to user equipment devices 1207, 1208 and 1210. Media content source 1202 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Media content source 1202 may be the originator of content (e.g., a television broadcaster, a Webcast provider, etc.) or may not be the originator of content (e.g., an on-demand content provider, an Internet provider of content of broadcast programs for downloading, etc.). Media content source 1202 may include cable sources, satellite providers, on-demand providers, Internet providers, over-the-top content providers, or other providers of content. Media content source 1202 may also include a remote media server used to store different types of content (including video content selected by a user), in a location remote from any of the client devices. Media content source 1202 may also provide metadata that can be used to identify important segments of media content as described above.

Client devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices (such as, e.g., server 1204), which may be located centrally or at distributed locations, that provide cloud-based services to various types of users and devices connected via a network such as the Internet via communication network 1206. In such embodiments, user equipment devices may operate in a peer-to-peer manner without communicating with a central server.

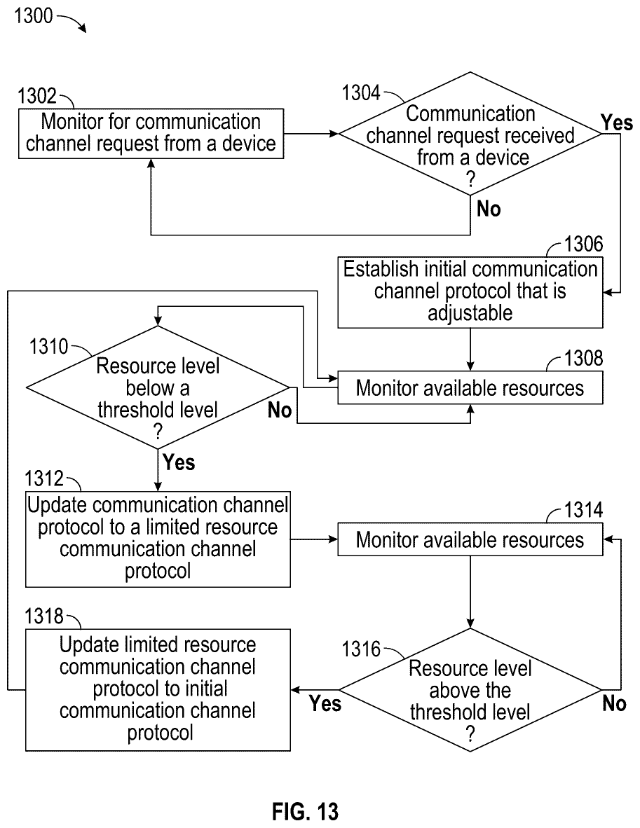

FIG. 13 is flowchart of detailed illustrative process 1300 for managing adjustable communication protocols, in accordance with some embodiments of this disclosure. Process 1300 may be implemented at least in part by, for example, control circuitry 1104 of FIG. 11, I/O path 1102 (e.g., circuitry) of FIG. 11, and/or control circuitry 1211 of FIG. 12. In various embodiments, the individual steps of process 1300 may be implemented by one or more components of the devices and applications of FIGS. 1-12. Although the present disclosure may describe certain steps of process 1300 (and of other processes described herein) as being implemented by certain components of the devices and applications of FIGS. 1-12, this is for purposes of illustration only, and it should be understood that other components of the devices and systems of FIGS. 1-12 may implement those steps instead. In addition, one or more steps of process 1300 may be incorporated into or combined with one or more steps of any other process or embodiment.

In some embodiments, process 1300 begins at 1302, where the control circuitry (e.g., control circuitry 1104 of FIG. 11 and/or control circuitry 1211 of FIG. 12), monitors for a communication channel request from a device. In some implementations, process 1300 proceeds to 1304 where the control circuitry determines if a communication channel request has been received from a device. In some embodiments, when the control circuitry determines that a communication channel request has not been received from a device (e.g., 1304=No), process 1300 returns to 1302. In some implementations, when the control circuitry determines that a communication channel request has been received from a device (e.g., 1304=Yes), process 1300 proceeds to 1306, where the control circuitry establishes initial communication channel protocol for the communication channel, the communication channel protocol being adjustable (e.g., and is used to transmit control data to maintain the communication channel). For example, in some embodiments, the control circuitry establishes the communication channel over a network and transmits control data (e.g., keep-alive messages, an indication of a size and a frequency of messages to be transmitted, an indication of a compression level for messages to be transmitted, an indication to prioritize either speed of transmission or error resiliency of transmissions, an indication of a maximum frame size of data to be transmitted). In some implementations, at 1308, the control circuitry monitors available resources (e.g., battery level, latency, CPU/GPU usage). In some implementations, at 1310, the control circuitry determines whether the resource level is below a threshold level (e.g., by measuring one or more resource parameters indicative of one or more resources available to the device), calculating a condition score, and determining that the condition score drops below a high resource level range). In some embodiments, when the control circuitry determines that the resource level (e.g., of the device and/or the server) is not below a threshold level (e.g., 1310=No), process 1300 returns to 1308. In some implementations, when the control circuitry determines that the resource level (e.g., of the device and/or the server) is below a threshold level (e.g., 1310=Yes), process 1300 proceeds to 1312, where the control circuitry updates the communication channel protocol (e.g., updates at least one attribute of the control data) to a limited resource communication channel protocol (e.g., increases a keep-alive interval, increases batch size, increases transmission interval, increases compression level). In some embodiments, such combined (e.g., normalized) condition score for a plurality of parameters is compared to a threshold to determine whether to update at least one attribute of control data, and/or scores for respective parameters may be compared to respective thresholds for the parameters.

In some embodiments, at 1314, the control circuitry monitors available resources (e.g., battery level, latency, CPU/GPU usage, one or more parameters indicative of one or more resources available to the device). In some implementations, at 1316, the control circuitry determines whether the resource level is above a threshold level (e.g., by measuring resource parameters, calculating a condition score based on the measured resource parameters, and determining that the condition score is in a high resource level range). In some embodiments, when the control circuitry determines that the resource level (e.g., of the device and/or the server) is not above a threshold level (e.g., 1316=No), process 1300 returns to 1314. In some implementations, when the control circuitry determines that the resource level (e.g., of the device and/or the server) is above a threshold level (e.g., 1316=Yes), process 1300 proceeds to 1318, where the control circuitry updates the limited resource communication channel protocol to the initial communication channel protocol (e.g., decreases a keep-alive interval, decreases batch size, decreases transmission interval, decreases compression level). In some embodiments, process 1300 returns to 1308 where it continues to monitor available resources.

Throughout the specification the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A computer-implemented method comprising:
establishing a communication channel over a network between a client device and a server, wherein control data is transmitted over the communication channel to maintain the communication channel;
determining one or more parameters indicative of one or more resources available to the client device;
calculating a condition score for the client device based at least in part on the one or more parameters; and
updating at least one attribute of the control data based at least in part on determining that the condition score is below a threshold.

2. The method of claim 1, the method further comprising:
determining one or more server parameters indicative of one or more resources available to the server;
calculating a server condition score for the server based at least in part on the one or more server parameters; and
updating the at least one attribute of the control data further based at least in part on the server condition score.

3. The method of claim 1, wherein:
the communication channel is established using a Websocket protocol;
the control data is associated with the Websocket protocol; and
the Websocket protocol enables the at least one attribute of the control data associated
with the Websocket protocol to be modified based at least in part on the condition score.

4. The method of claim 1, wherein:
the one or more parameters indicative of one or more resources available to the client device comprise one or more of a battery level, network bandwidth, network latency, central processing unit (CPU) usage, or general processing unit (GPU) usage; and
the condition score is calculated by normalizing a measurement of each parameter of the one or more parameters and applying respective weights to each normalized parameter.

5. The method of claim 1, wherein:
the control data comprises keep-alive messages that are transmitted at a first frequency; and
the updating the at least one attribute of the control data comprises updating the first frequency to a second frequency that is less than the first frequency.

6. The method of claim 1, wherein:
the control data comprises an indication of a size and a frequency of messages transmitted by the server to the client device; and
the updating the at least one attribute of the control data comprises increasing the size and decreasing the frequency of messages transmitted by the server to the client device.

7. The method of claim 1, wherein:
the control data comprises an indication of a compression level for messages transmitted by the server to that the client device; and
the updating the at least one attribute of the control data comprises increasing the compression level for messages transmitted by the server to the client device.

8. The method of claim 1, wherein:
the control data comprises an indication of prioritizing a speed of message transmission over error resilience of message transmission;
the updating the at least one attribute of the control data comprises prioritizing error resilience of message transmission over the speed of message transmission.

9. The method of claim 1, wherein:
the control data comprises an indication of a maximum frame size of data to be transmitted by the server to the client device;
the updating the at least one attribute of the control data comprises decreasing the maximum frame size; and
the server utilizes adaptive frame segmentation to reduce a frame size of data to be transmitted to the client device based at least in part on the decreased maximum frame size.

10. The method of claim 1, wherein the client device is a first device, the method further comprising identifying a second device in the proximity of the first device, wherein:
the control data comprises an indication that the server is to transmit data to the first device; and
the updating the at least one attribute of the control data comprises indicating that data is to be transmitted to the second device instead of the first device, wherein the second device is proximate to the first device, and the second device transmits the data received from the server to the first device.

11. The method of claim 1, further comprising:
determining an engagement level of a user with the client device based at least in part on one or more of a frequency of interactions with the client device or a determined proximity of the user to the client device, wherein:
the updating of the at least one attribute of the control data comprises, based at least in part on the engagement level, refraining from transmitting non-critical data to the client device.

12. The method of claim 11, wherein:
the determining the engagement level comprises detecting movement of the client device by a sensor associated with the client device.

13. A system comprising:
input/output circuitry configured to:
establish a communication channel over a network between a client device and a server; and
transmit control data over the communication channel to maintain the communication channel
control circuitry configured to:
determine one or more parameters indicative of one or more resources available to the client device;
calculate a condition score for the client device based at least in part on the one or more parameters; and
update at least one attribute of the control data based at least in part on determining that the condition score is below a threshold.

14. The system of claim 13, wherein the control circuitry is further configured to:
determine one or more server parameters indicative of one or more resources available to the server;
calculate a server condition score for the server based at least in part on the one or more server parameters; and
update the at least one attribute of the control data further based at least in part on the server condition score.

15. The system of claim 13, wherein:
the communication channel is established using a Websocket protocol;
the control data is associated with the Websocket protocol; and
the Websocket protocol enables the at least one attribute of the control data associated with the Websocket protocol to be modified based at least in part on the condition score.

16. The system of claim 13, wherein:
the one or more parameters indicative of one or more resources available to the client device comprise one or more of a battery level, network bandwidth, network latency, central processing unit (CPU) usage, or general processing unit (GPU) usage; and
the condition score is calculated by normalizing a measurement of each parameter of the one or more parameters and applying respective weights to each normalized parameter.

17. The system of claim 13, wherein:
the control data comprises keep-alive messages that are transmitted at a first frequency; and
the control circuitry is configured to update the at least one attribute of the control data by updating the first frequency to a second frequency that is less than the first frequency.

18. The system of claim 13, wherein:
the control data comprises an indication of a size and a frequency of messages transmitted by the server to the client device; and
the control circuitry is configured to update the at least one attribute of the control data by increasing the size and decreasing the frequency of messages transmitted by the server to the client device.

19. The system of claim 13, wherein:
the control data comprises an indication of a compression level for messages transmitted by the server to that the client device; and
the control circuitry is configured to update the at least one attribute of the control data by increasing the compression level for messages transmitted by the server to the client device.

20. The system of claim 13, wherein:
the control data comprises an indication of prioritizing a speed of message transmission over error resilience of message transmission;
the control circuitry is configured to update the at least one attribute of the control data by prioritizing error resilience of message transmission over the speed of message transmission.
